(19) United States
(12) Patent Application Publication
(10) Pub. No.: US 2007/0287544 A1
(43) Pub. Date: Dec. 13, 2007

(54) GAMING MACHINE

(75) Inventors: Jun HIRATO, Tokyo (JP); Yasuaki TANABE, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/757,785

(22) Filed: Jun. 4, 2007

(30) Foreign Application Priority Data
Jun. 9, 2006 (JP) P2006-161664

(51) Int. Cl. G07F 17/32

(52) U.S. Cl. 463/46; 362/367

(57) ABSTRACT

A gaming machine includes: a cabinet; a display portion that is provided on the cabinet and displays information related to a game; an operation unit that is provided on the cabinet and allows a player to input operations for playing the game; and a plurality of light emitting units that are arranged to surround a game area defined on the cabinet to include the display portion and the operation unit.

### CROSS-REFERENCE TO THE RELATED APPLICATION(S)

The present application is based upon and claims priority from prior Japanese Patent Application No. 2006-161664, filed on Jun. 9, 2006, the entire content of which are incorporated herein by reference.

### TECHNICAL FIELD

The present invention relates to a gaming machine, such as a slot machine, in which symbols aligned in a plurality of arrays are variably displayed.

### BACKGROUND

Conventionally, there is known a gaming machine, such as a slot machine, which provides a game to a player by causing a reel (a variable display device) arranged with a plurality of symbols thereon to rotate. As the variable display device installed in such kind of gaming machines, there are known a type that is provided with mechanical reels that actually rotates, and a type that is provided with a display device, such as an LCD panel and a CRT display, which displays an image of rotating reels (so-called video reels).

The gaming machine generally provides the game when a game medium (medals or coins) is inserted by the player and the player performs a start operation, as such by pressing a spin button. The gaming machine then controls the variable display device to rotate a plurality of reels, and controls the variable display device to stop the reels to display symbols to be aligned in a predetermined combination in accordance with a result of an internal lottery. The gaming machine pays out a predetermined amount of game medium to the player in accordance with the combination of the stopped symbols.

As a display portion for displaying game details to the player, and an operation unit for entering an operation of the game, are areas on which the player closely focuses, in consideration of a strain on the player's eyes and a fatigue of the player, information relating to the game is displayed with an appropriate amount of light.

In U.S. Pat. No. 6,334,612, there is proposed an upright-type slot machine having a cabinet, a display portion, a controller, an operation unit, and a coin tray. The slot machine has an installation angle and an installation height of the display portion and the operation unit being designed based on ergonomics in order to minimize a physical burden on the player performing a repetitive motion in the same posture for a long time.

However, in the conventional gaming machine, although it is designed to provide attracting game and improved operationality to the player actually playing the game, no consideration is made to the gaming machine itself to attract the surrounding galleries watching the game played by the player.

### SUMMARY

One of objects of the present invention is to provide a gaming machine that is improved with characteristic for attracting the galleries.

According to a first aspect of the invention, there is provided a gaming machine including: a cabinet; a display portion that is provided on the cabinet and displays information related to a game; an operation unit that is provided on the cabinet and allows a player to input operations for playing the game; and a plurality of light emitting units that are arranged to surround a game area defined on the cabinet to include the display portion and the operation unit.

According to a second aspect of the invention, there is provided a gaming machine including: a cabinet; a display portion that is provided on the cabinet and displays information related to a game; an operation unit that is provided on the cabinet and allows a player to input operations for playing the game; a plurality of light emitting units that are arranged to surround a game area defined on the cabinet to include the display portion and the operation unit; and an inclined portion that is formed to incline more toward the display portion at a part where distant in a direction rearward from a front face of the display portion, the inclined portion being formed to protrude outward from a side face of the cabinet, wherein a subset of the light emitting units is disposed on the inclined portion.

According to a third aspect of the invention, there is provided a gaming machine including: a cabinet; a display portion that is provided on the cabinet and displays information related to a game; a plurality of display devices that are provided within the display portion; an operation unit that is provided on the cabinet and allows a player to input operations for playing the game; a plurality of light emitting units that are arranged to surround a game area defined on the cabinet to include the display portion and the operation unit; and a controller that operates to: control the display devices to variably display a plurality of symbols for a predetermined time period when a start command is input through the operation unit to start the game; and pay out an award to the player in accordance with a combination of the symbols displayed stopped; and an inclined portion that is formed to incline more toward the display portion at a part where distant in a direction rearward from a front face of the display portion, the inclined portion being formed to protrude outward from a side face of the cabinet, wherein a subset of the light emitting units is disposed on the inclined portion.

### BRIEF DESCRIPTION OF THE DRAWINGS

In the accompanying drawings:

FIG. 1 is a perspective view showing an embodiment of a gaming machine according to the present invention;

FIG. 2 is a front view of the gaming machine shown in FIG. 1;

FIG. 3 is a side view of the gaming machine shown in FIG. 1;

FIG. 4 is a sectional view along line IV-IV of FIG. 2;

FIG. 5A is an enlarged sectional view showing a reflecting face, and FIG. 5B is a plan view showing reflected light;

FIG. 6 is a plan view showing a relationship between a player facing the gaming machine and surrounding galleries;

FIG. 7 is a front view showing the relationship between the player facing the gaming machine and the galleries;

FIG. 8 is a side view showing a state in which an upper front door (a first door) is opened;

FIG. 9 is a perspective view showing a state in which the upper front door is opened;

FIG. 10 is a perspective view showing a state in which a lower front door (a second door) is opened;

FIG. 11 is an enlarged sectional view of a main portion of a boundary portion between the upper front door and the lower front door;

FIG. 12 is an enlarged fragmentary sectional view of a main portion of the lower front door;

FIG. 13 is an enlarged perspective view showing a lower portion of the gaming machine;

FIG. 14 is a partially fractured side view of a front side of a lower portion of a cabinet;

FIG. 15 is a side view showing a state in which the player is playing the gaming machine, and a gallery is watching a slot game;

FIG. 16 is a perspective view of the gaming machine according to the embodiment.

FIG. 17 is an enlarged perspective view showing a right side of a variable display portion;

FIG. 18 is a sectional view taken along P-P line shown in FIG. 17;

FIG. 19 is an enlarged perspective view showing a right side of an upper display portion;

FIG. 20 is a perspective view of the gaming machine to which a external display device is attached;

FIG. 21 is a perspective view of the external display device;

FIG. 22 is a sectional view taken along R-R line shown in FIG. 21;

FIG. 23 is an enlarged sectional view showing right and left side portions of the external display device;

FIG. 24 is an enlarged side view showing a speaker in FIG. 2;

FIG. 25 is a sectional view taken along XXV-XXV line shown in FIG. 24;

FIG. 26 is an exploded perspective view of the speaker shown in FIG. 24;

FIG. 27 is a front view showing the speaker in a state in which a net is removed;

FIG. 28 is a right side view showing a state in which the front door is opened;

FIG. 29 is a front view showing an arrangement of a speaker box, a substrate and speaker lamps in the speaker;

FIG. 30 is an enlarged side view showing an inclined face and the speaker lamps;

FIG. 31 is an enlarged sectional view showing the inclined face and the speaker lamps;

FIG. 32 is a perspective view showing the speaker shown in FIG. 24 from a direction facing the inclined face;

FIG. 33 is a perspective view showing the speaker shown in FIG. 24 from diagonally behind the gaming machine;

FIG. 34 is an enlarged view showing a main portion of a top lamp of the gaming machine in FIG. 1;

FIG. 35 is a sectional view of the top lamp taken along line XXXV-XXXV shown in FIG. 34;

FIG. 36 is a front view of the top lamp shown in FIG. 34 with a cover plate omitted;

FIG. 37 is a sectional view of a strip-shaped lamp taken along line XXXVII-XXXVII shown in FIG. 36;

FIG. 38 is a view showing the strip-shaped lamp of FIG. 36 visible to the player;

FIG. 39 is a sectional view showing a strip-shaped lamp of a different aspect;

FIG. 40 is a view showing a strip-shaped lamp of a different aspect;

FIG. 41 is a perspective view showing a gaming machine according to another embodiment of the invention;

FIG. 42 is a block diagram showing an internal configuration of a whole of the gaming machine shown in FIG. 1;

FIG. 43 is a block diagram showing a configuration of a light emitting unit shown in FIG. 2;

FIG. 44 is a block diagram showing an internal configuration of a subsidiary circuit board shown in FIG. 2;

FIG. 45 is a block diagram showing an internal configuration of a topper effect producing device shown in FIG. 2; and

FIG. 46 is a flowchart showing a procedure of an effect process in the topper effect producing device according to the invention.

### DETAILED DESCRIPTION

Hereafter, a detailed description will be given, while referring to the drawings, of preferred embodiments of a gaming machine according to the invention.

Overall Description of Gaming Machine

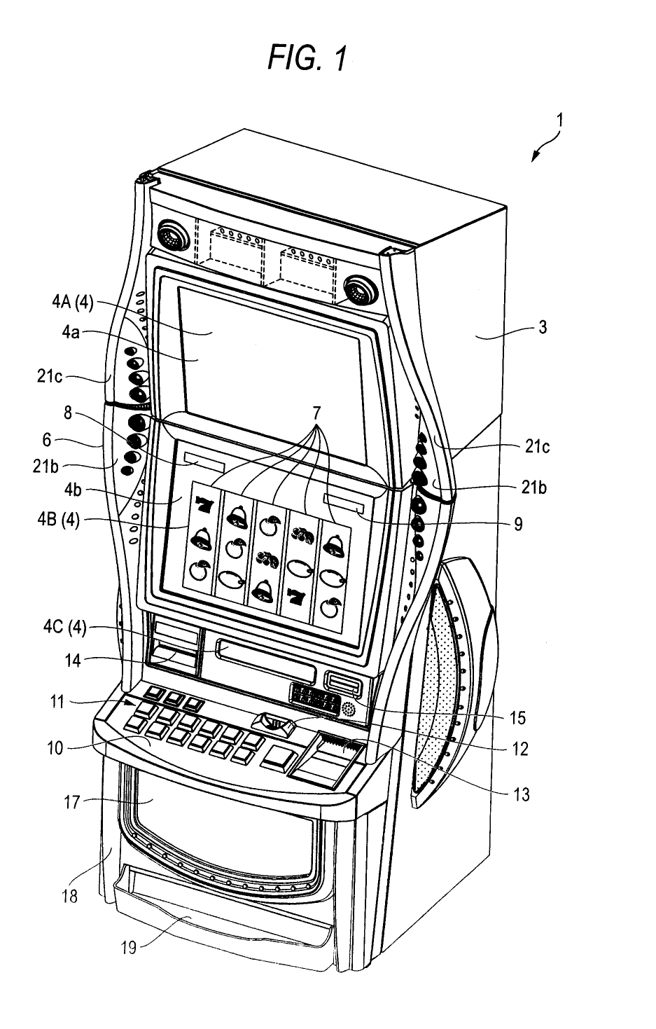

As shown in FIGS. 1 to 3, a gaming machine 1 is configured as an upright-type slot machine to be installed in a game arcade such as a casino. The gaming machine 1 has a cabinet 3 for housing electrical or mechanical parts for performing a various gaming state. A display portion 4 is provided for displaying game information based on a game operation of a player. The display portion 4 includes, for example, an upper display portion 4A, a middle display portion 4B and a lower display portion 4C, each of the display portions 4A to 4C is attached to a front surface of the vertically long cabinet 3.

The upper display portion 4A includes a liquid crystal panel for displaying a payout table, a display of game rules and a bonus game, and the like during a game. The upper display portion 4A is inclined to be tilted forward in order to improve a visibility for a player whose view point is positioned approximately at a height of the middle display portion 4B.

The middle display portion 4B is provided with a rotating symbol display panel on which the player constantly keeps a close watch, is a transparent liquid crystal panel fixed to an upper front door 6 of the cabinet 3. The middle display portion 4B is provided with five transparent display windows 7 to allow symbols arranged on five mechanical reels disposed inside the cabinet 3 be seen therethrough by the player.

A plurality of pay lines traversing the five display windows 7 horizontally and diagonally are displayed on the middle display portion 4B. In the middle display portion 4B, an animation effect is performed at the time of a winning or the like.

A payout amount display portion 8 and a credit amount display portion 9 are provided in an upper portion of the middle display portion 4B. The middle display portion 4B is inclined in such a way that an upper portion tilts rearward, as the player, whose view point is positioned approximately at the height of the middle display portion 4B, looks slightly down at it, whereby to allow the player to look at a screen of the middle display portion 4B from a comfortable position.

Although it is assumed in the embodiment that a variable display of the symbols is performed with the mechanical reels installed on a rear surface of the middle display portion 4B, it is also acceptable to display video reels on the middle display portion 4B, instead of the mechanical reels. Also, a number of the mechanical reels is not limited to five.

The lower display portion 4C includes a liquid crystal panel for displaying points recorded on a card or game points. A numeric value displayed on the lower display portion 4C is based on a display result of the middle display portion 4B, when symbols aligned on the middle display portion 4B and a “winning combination” is satisfied, the game points displayed on the lower display portion 4C is added to based on a big bonus result. A ticket printer 14 is installed on a left side of the lower display portion 4C, and a card reader 15 is installed on a right side of the lower display portion 4C.

An operation table 10 protruding forward from a front of the cabinet 3 being disposed below the lower display portion 4C, operation buttons 11 (for example, a BET button, a COLLECT button, a START button, a STOP button and the like) serving as an operation unit for the player to perform an operation of the game are arranged on the operation table 10. Furthermore, a coin slot 12 and a bill slot 13 are provided on the operation table 10.

A belly panel 17 is disposed below the operation table 10. The belly panel 17 is a plastic panel on which an image relating to the game is printed. The belly panel 17, as well as being fixed to a lower front door 18, is lit up by a cold-cathode tube. A coin tray 19 for collecting coins paid out based on a game result is disposed below the belly panel 17.

Illumination

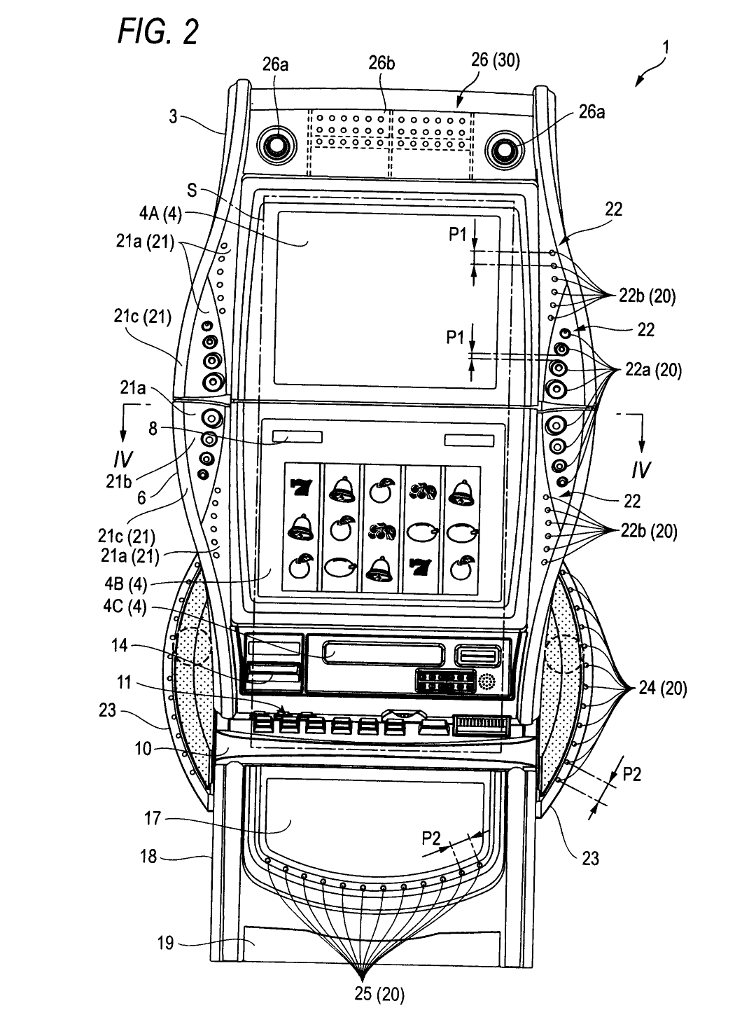

As shown in FIGS. 1 and 2, a plurality of light emitting units 20 are arranged to surround a game area S. As shown in FIG. 2, the game area S is defined on the cabinet 3 as an area including the operation buttons 11 (operation unit) arranged on the operation table 10 and the display portion 4 that includes the upper display portion 4A, the middle display portion 4B and the lower display portion 4C.

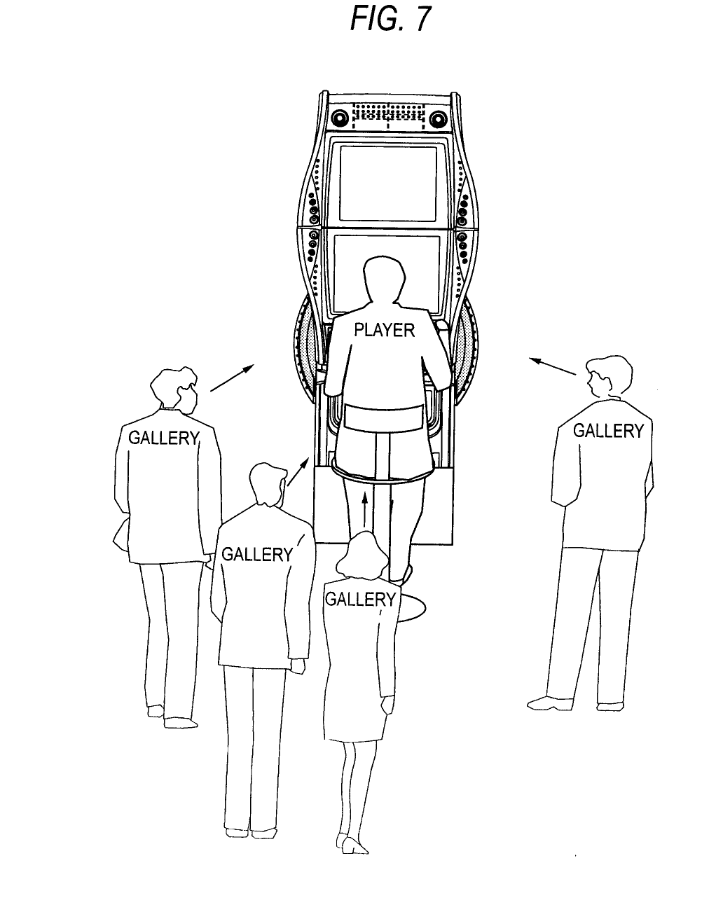

As shown in FIG. 7, the player is positioned in such a way that the view point of the player is positioned approximately at the height of the middle display portion 4B. The position of the player is also in an approximate center of the game area S, which is an area on which the player focuses most closely.

The light emitting units 20 includes side lamps 22, speaker lamps 24, under lamps 25, and a top lamp 26. The side lamps 22 are provided on inclined portions 21 to protrude bow-like from both right and left end portions on the front of the cabinet 3 and on sides thereof across the upper display portion 4A, the middle display portion 4B and the lower display portion 4C. The speaker lamps 24 are provided on bow shaped speakers 23 protruding laterally from both right and left end portions of the cabinet 3 in a vicinity of the operation table 10. The speaker lamps are arranged along edges of the speakers 23. The under lamps 25 are provided on the lower front door 18 and arranged along a lower edge of the belly panel 17. The top lamp 26 is provided above the upper display portion 4A. The light emitting units 20 create an attractive illumination by a light emitting control.

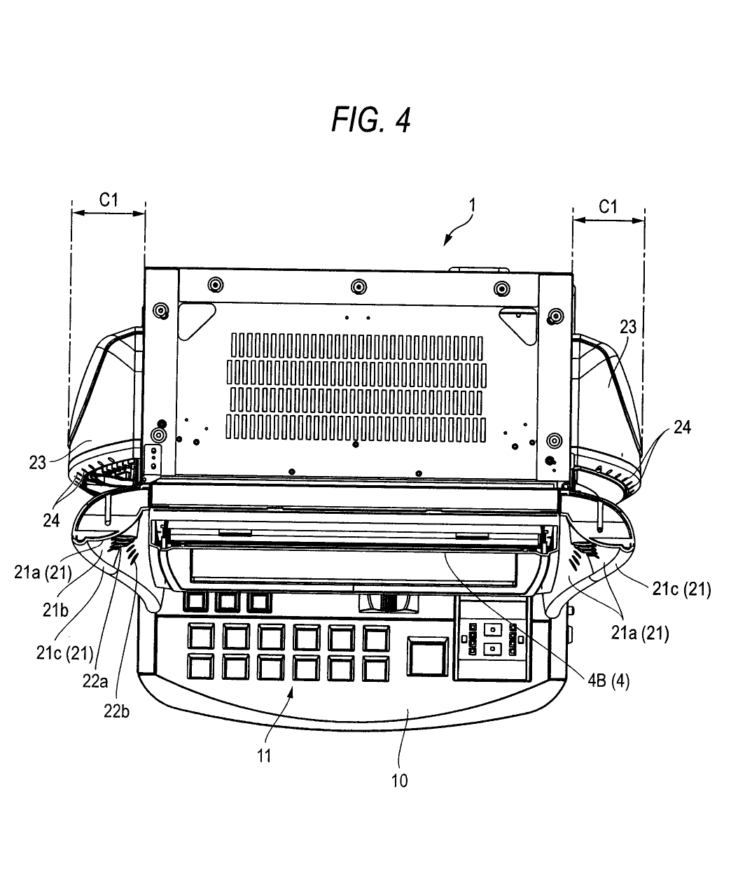

As shown in FIGS. 2 and 4, the right and left inclined portions 21 are inclined toward the display portions 4A and 4B as they are distant front surfaces 4a and 4b (refer to FIG. 1) of the display portions 4A and 4B. The inclined portions 21 are each configured of an inclined face 21a and a thick frame 21c, and a chrome-plated reflecting face 21b being provided in a center of the inclined face 21a. The inclined face 21a, on which subsidiary side lamps 22b are disposed, is textured.

On an outer edge of each inclined portion 21, the bow shaped thick frame 21c, of which a central portion swells outward, extends in an vertical direction and, as well as having a semicircular cross-section, is chrome-plated. Eight main side lamps 22a are arranged in the vertical direction on each reflecting face 21b. The main side lamps 22a serve as light emitting units which decrease in size gradually toward a bottom or a top from a center. In the side lamps 22, the subsidiary side lamps 22b, being arranged in the vertical direction above and below the main side lamps 22a, are linearly arranged in such a way as to be approximately continuous with the main side lamps 22a.

As described above, the gaming machine 1 includes the cabinet 3 having the display portion 4 that displays information relating to the game, and the operation buttons 11 that serves as the operation unit that allows the player to input operations for playing the game. The light emitting units 20 are disposed in such a way as to surround the game area S including the display portion 4 and the operation unit 11.

As the light emitting units 20 are disposed in such a way as to surround the game area S including the display portion 4 and the operation unit 11, it becomes possible to cause the gaming machine 1 itself to emit light in such a way as to surround the game area S, so that the game machine 1 itself becomes attractive to surrounding galleries. Simultaneously, as the display portion, on which details of a game actually being played are displayed, and the operation unit, with which it is possible to confirm an operation procedure, method and rules of a game the player plays, are places of deepest concern to the surrounding galleries, there is an advantage of heightening a degree of focusing on the game area S including these kinds of display portion and operation unit. For example, the galleries observe the game from positions such as those shown in FIG. 7.

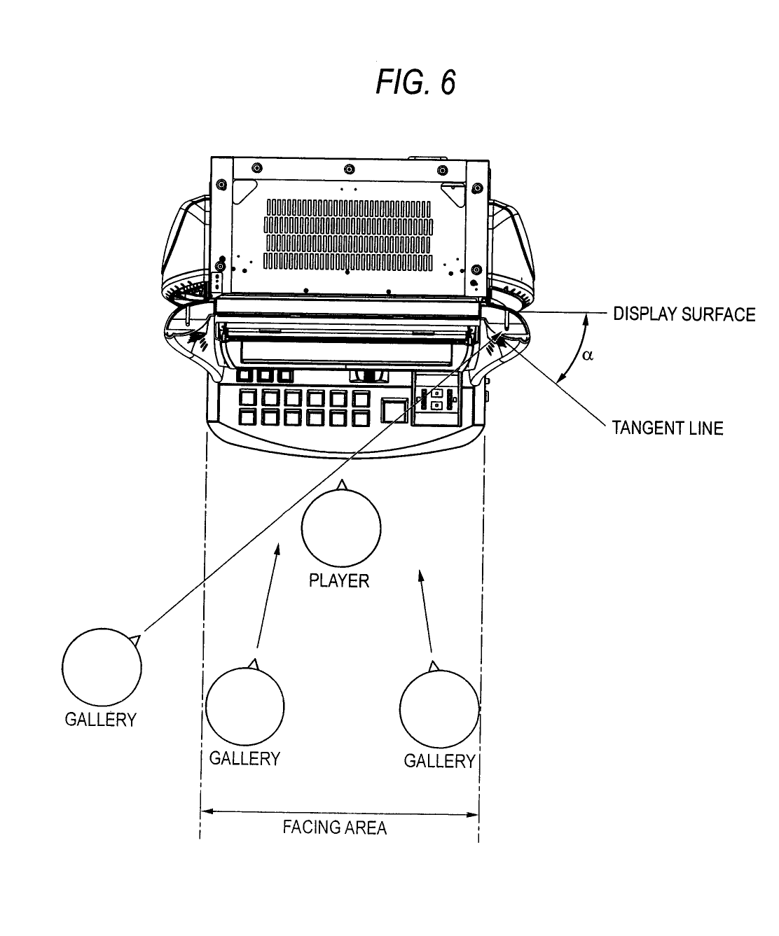

Also, some of the light emitting units 20 are disposed on the inclined faces 21a inclined toward the display portions 4A and 4B as they are distanced from the front surfaces 4a and 4b (refer to FIG. 1) of the display portions 4A and 4B. As the inclined portion 21 disposed at a player's right hand approximately faces a gallery diagonally behind the player to the left, and the inclined portion 21 disposed at a player's left hand approximately faces a gallery diagonally behind the player to the right, as shown in FIG. 6, it is easy for these kinds of inclined face 21a, which also approximately face the galleries diagonally behind the player, to become visible to the relevant galleries and, the game machine 1 itself becomes attractive by means of light from the lamps 22a and 22b disposed on the inclined faces 21a, and it is possible to obtain an advantage of attracting a large number of galleries to the game machine 1.

As shown in FIG. 6, by inclining the light emitting units 20 on the inclined faces 21a by an angle α, it being possible to cause the light to face a gallery in other than a facing area, particularly a gallery diagonally behind the player, it is easy for a gallery who has noticed the light to be guided to the display portions 4A and 4B. The angle α is preferably about 30 to 60 degrees.

Also, the inclined portions 21 protrude from the side portions of the cabinet 3. As a result, it being possible to make the game machine 1 itself look larger by an amount equivalent to widths C1 of the inclined portions 21, a distinctive cabinet 3 is created and, as it is possible to secure a wide effective installation area of the light emitting units 20 performing an attractive advertisement to the galleries, as well as it becoming possible to improve a degree of attraction of the galleries to the gaming machine 1, it is possible to make effective use of a space between gaming machines installed at regular intervals for an opening and closing operation of the front doors 6 and 17.

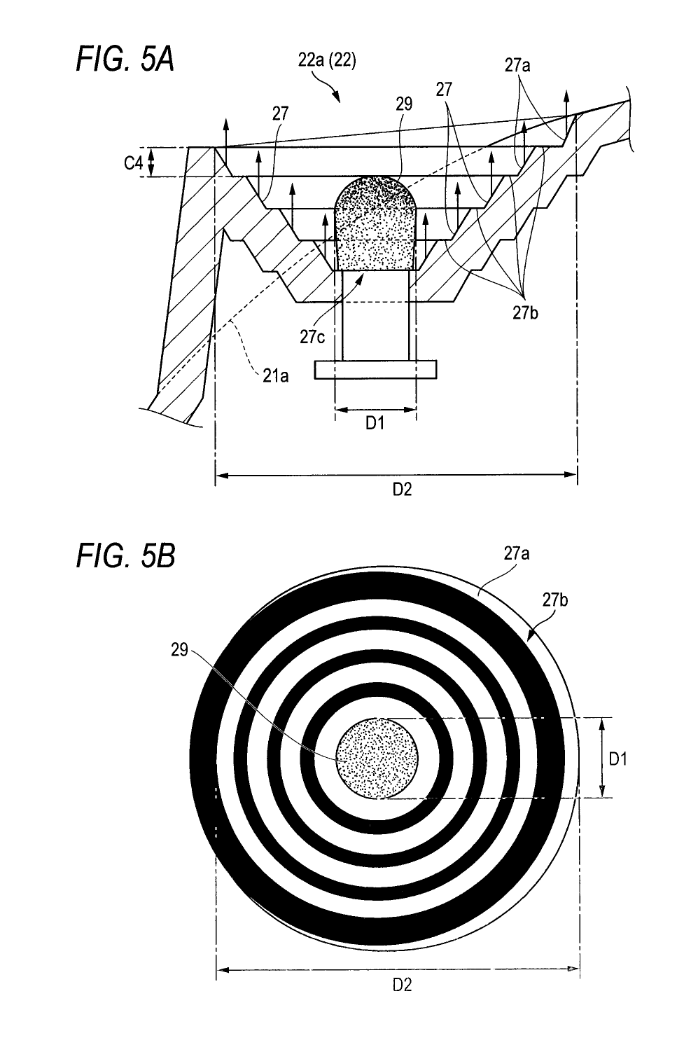

Furthermore, as shown in FIG. 5A, the main side lamps 22a arranged on the inclined portions 21 are each configured of a light emitting source 29 having an LED, and a funnel-shaped reflecting face 27 surrounding the light emitting source 29. With this kind of configuration, as light emitted from the LED 29 is reflected by the funnel-shaped reflecting face 27 surrounding the LED 29, it becomes possible to make a diameter D2 of apparent light look larger than a diameter D1 of the actual light emitted from the LED 29 and, as well as it being possible to improve the degree of attraction, even in a case in which a quantity of light from the LED 29 has been suppressed, it is possible to make the diameter D2 look larger than the diameter D1 of the actual light emitted from the LED 29, so it is possible to reduce the diameter D2 by that amount, meaning that an energy-saving advantage can also be obtained. Furthermore, in a vicinity of the game area S, as the reflecting face 27 is formed in the funnel shape, the light emitting source 29 is disposed a distance C4 to a rear of a reflecting portion, so, without the light emitted from the lamps 22a becoming directly visible to the player, it is possible to reduce a strain on and a fatigue of the player's eyes.

The reflecting face 27 is formed to have a plurality of stepped faces 27c having different depth. The light from the LED 29 is reflected forward (in an arrowed direction in the figure) by inclined faces 27a forming the funnel shape within the reflecting face 27, while the light is not reflected by a stepped faces 27b parallel to a bottom face 27c on which the LED 29 is installed. Consequently, as it is possible to produce ring-shaped shadowed portions within the reflecting face 27, a number of ring beams of light corresponding to a number of steps is generated as shown in FIG. 5B. Accordingly, it being possible to impart a decorative element to the light, and it is possible to improve the degree of attraction of the surrounding galleries. Furthermore, as the light has the shadowed portions, it being possible to reduce a quantity of light visible to the player, it is possible to reduce the strain on and the fatigue of the player's eyes.

Furthermore, as shown in FIG. 2, the speaker lamps 24 installed on side surfaces of the cabinet, although installed a predetermined distance rearward from the front surface of the cabinet 3, are linearly arranged in such a way as to be visually approximately continuous with the subsidiary side lamps 22b and the under lamps 25. As the speaker lamps 24 are arranged along edges of speaker cabinets 23, it is possible to further accentuate the speaker cabinets 23 protruding laterally from the cabinet 3, and the side surfaces of the cabinet 3.

Furthermore, the under lamps 25 are linearly arranged in such a way as to be visually approximately continuous with the speaker lamps 24. The belly panel 4C is accentuated by the under lamps 25.

The top lamp 26 is configured by power lamps 26a disposed on both sides and a strip-shaped lamp 26b arranged in a center in a horizontal direction. Each of the power lamps 26a generates very strong light by means of a fisheye lens, and the strip-shaped lamp 26b generates horizontally long light by arranging LED's horizontally. The thus configured top lamps 26 are linearly arranged in such a way as to be visually approximately continuous with the subsidiary side lamps 22b.

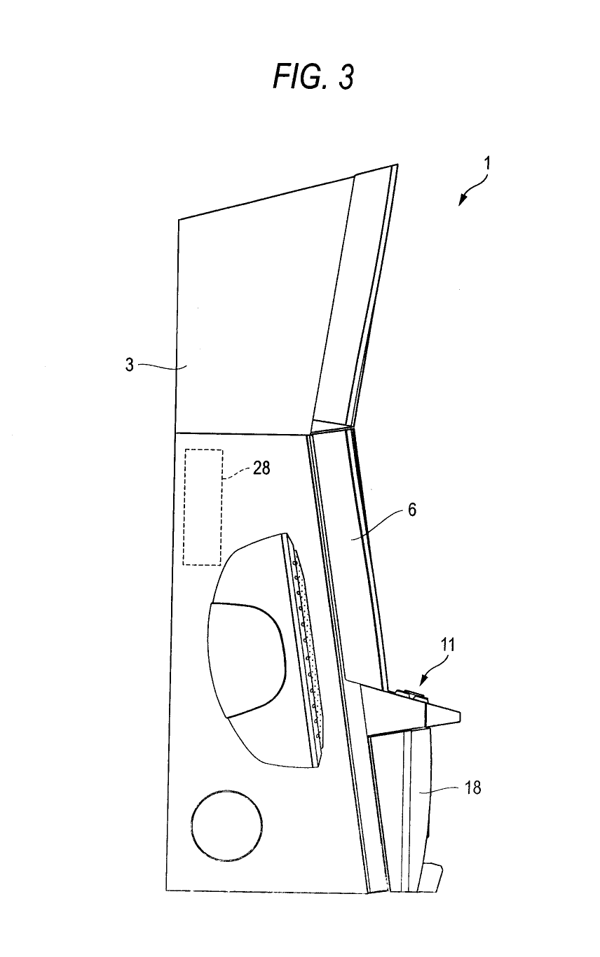

A controller 28 (refer to FIG. 3) is disposed in the cabinet 3. The controller 28 controls the light emitting units 20 to blink. The lamps 22a, 22b, 24, 25, 26a and 26b controlled by the controller 28 are linearly arranged. Accordingly, as it is possible to create moving light such as a flowing light illumination, the degree of attraction of the galleries to the gaming machine 1 is further improved. Also, for example, even in the event that the speaker cabinets 23 provided with some of the light emitting units 20, not being in plane with the front doors 6 and 17, the display portion 4 or the like, are withdrawn rearward, in the event that an unevenness exists in a place installed with the light emitting units 20, or in the event that the light emitting units 20 are not equally spaced, as a frame such as fringes the game area S can be dramatized by the light, it becomes easier for the galleries, or a gallery who is about to start the game, to identify a game area S worthy of notice.

Intervals P1 between the side lamps 22 disposed lateral to the display portion 4 are narrower than intervals P2 between the speaker lamps 24 and under lamps 25 disposed lateral to and below the operation buttons 11. With regard to the side lamps 22 disposed at the first intervals P1 and the speaker lamps 24 and under lamps 25 disposed at the second intervals P2, in a case of performing an execution of an identical blinking time control by means of the controller 28 in order to create the flowing light, as the second intervals P2 are set wider than the first intervals P1, a flow speed of beams of light arranged at the first intervals P1 can be made to look slower than a flow speed of beams of light arranged at the second intervals P2. Consequently, as a light flowing speed becomes slow on a periphery of the display portion most worthy of notice in the game area S on which the player and the galleries focus, it is possible to heighten a degree of focusing on the display portion 4 in the game area S. Herein, as long as the intervals P2 are set wider than the intervals P1, it is not necessary that the intervals P1 of the main side lamps 22a are identical to the intervals P2 of the subsidiary side lamps 22b, and it is not necessary either that the intervals P2 of the under lamps 25 are identical to the intervals P2 of the speaker lamps 24.

Front Doors

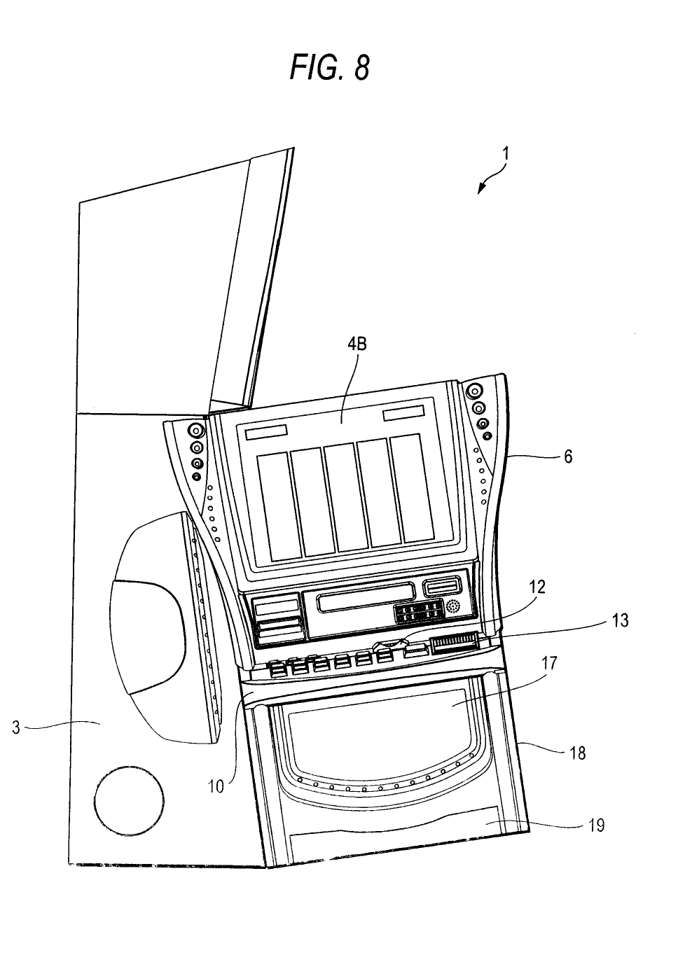

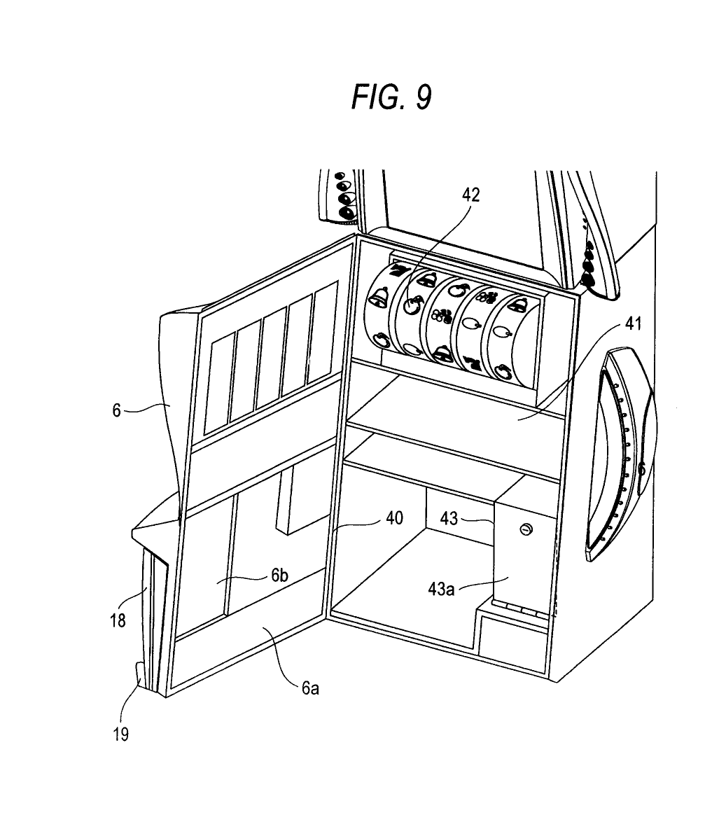

As shown in FIGS. 8 and 9, the gaming machine 1 includes the upper front door (a first door) 6 provided with the middle display portion 4B and the operation table 10, and the lower front door (a second door) 18 provided with the belly panel 17 and the coin tray 19. The upper front door 6 and the lower front door 18 open laterally, which provides an opening and closing operability, and the upper front door 6, as well as being provided on the front surface of the cabinet 3, is supported on a left side of the cabinet 3 via a hinge 40. As the upper front door 6 is connected by the hinge 40 to a left end of the cabinet 3, of which the front surface is inclined in such a way as to tilt rearward, the upper front door 6, when opened 90 degrees or more, can be opened in such a way that a right side is lifted up.

When the upper front door 6 is opened, the lower front door 18 also pivots along with the upper front door 6, and a large opening 41 appears in the front surface of the cabinet 3. By opening the upper front door 6, it is possible to perform maintenance of the mechanical reels 42 and a wiring inside the cabinet 3, and it is possible to expose a collection box 43 installed inside the cabinet 3. The collection box 43 is used for collecting bills inserted from the bill slot 13. Also, the opening 41 also being furnished with a coin hopper (not shown) in which coins inserted from the coin slot are accumulated, the coins pass through a chute 47 as necessary and, after passing through a coin tray chute 19a disposed on a right side as seen from a rear surface 18a of the lower front door 18, are paid out into the coin tray 19.

Furthermore, the middle display portion 4B is fixed to an upper portion of the upper front door 6, and a partition plate 6a is provided in a lower portion of the upper front door 6. A rectangular window 6b, through which an operator is allowed to access a cover 43a of the collection box 43, is provided on a right side of the partition plate 6a. The operator can see the collection box 43 from outside via the window 6b.

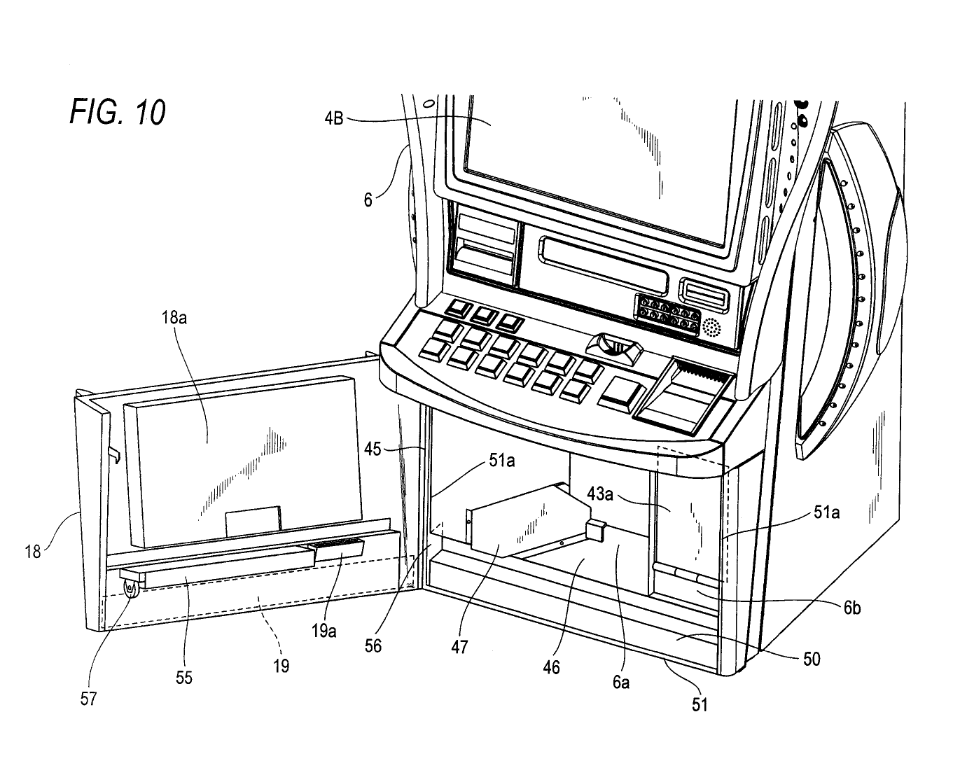

As shown in FIG. 10, the lower front door (the second door) 18 for opening and closing a part of the upper front door 6 is provided in a front lower portion of the upper front door 6. A left end of the lower front door 18 is supported on a front of a left end of the upper front door (the first door) 6 via a hinge 45. By opening the lower front door 18, a rectangular opening 46 appears and, the partition plate 6a of the upper front door 6 being disposed to a rear of the opening 46, the coin passing chute 47 for paying out the coins into the coin tray 19 is fixed to the partition plate 6a. Furthermore, the operator can unlock the cover 43a of the collection box 43 through the rectangular window 6b provided in the partition plate 6a. After the unlocking, by pulling the cover 43a down and forward, the operator can collect the bills in the collection box 43 via the window 6b.

As described, the coin tray 19 is fixed to a front lower end of the lower front door 18, which is mainly used for the bill collection or the like. The coin tray 19 extending over an approximately whole width of the lower front door 18, the coins paid out from the heretofore described coin hopper (not shown) disposed to the rear of the opening 41 pass through the chute 47 and, after passing through the coin tray chute 19a disposed on the right side as seen from the rear surface 18a of the lower front door 18, are accumulated in the coin tray 19.

In a case in which the coins are accumulated beyond an upper end of the coin tray 19, in the event that a maintenance of the gaming machine 1 or an operation of taking the bills out of the collection box 43 inside the gaming machine 1 is necessary, as shown in FIG. 8, even though the upper front door 6 or the lower front door 18 is opened, as the tray 19 is installed on the lower front door (the second door) 18, it is possible to smoothly open the upper front door 6 or the lower front door 18.

Also, even in a state in which the upper front door 6 or the lower front door 18 is opened, as the coin tray 19 is no longer in contact with the operator, the coin tray 19 not being an impediment to the operation in the cabinet 3, an operation effectiveness is improved. The coin tray 19 is one in which are accumulated not only the coins but also game media, such as medals, tokens, tickets or the like, paid out from the cabinet 3, or in which are placed belongings (for example, cigarettes, a handbag or the like) which belong to the player.

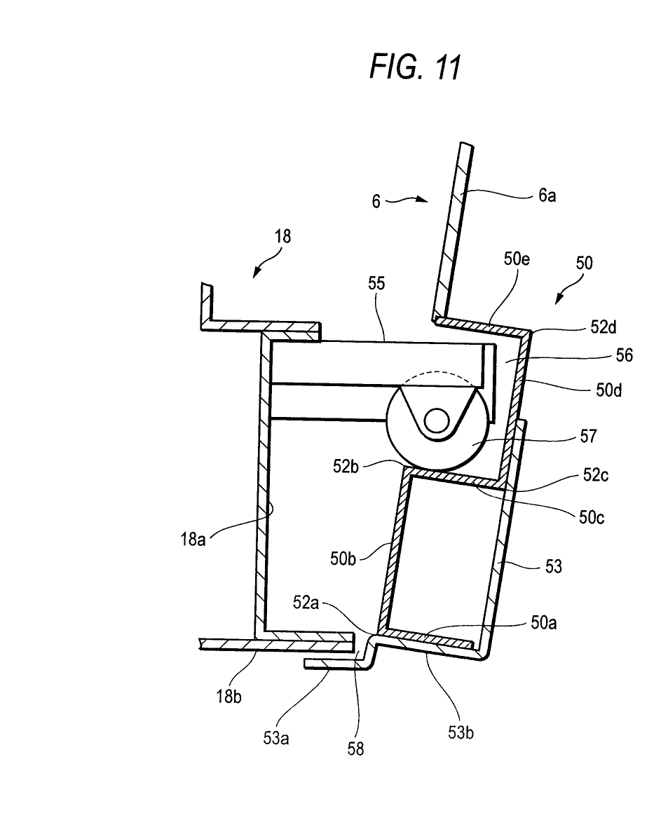

As shown in FIGS. 10 and 11, a reinforcing member 50 created by a bending formation is provided at a lower end of the partition plate 6a fixed to the upper front door 6. The reinforcing member 50 is connected in such a way as to span both side portions 51a of a frame 51 formed on a peripheral edge of the rectangular opening 46 which appears when the lower front door 18 is opened. An upper end of the reinforcing member 50 is fixed by welding to the lower end of the partition plate 6a of which a peripheral edge is fixed to the frame 51. Also, by the reinforcing member 50 being provided, as it is possible to stabilize the frame 51 of the upper front door 6, it is possible to reduce a distortion of the frame 51.

As the reinforcing member 50 is formed bending along bending lines 52a to 52d extending in a spanning direction, it is possible to achieve a rigidity of the reinforcing member 50 with a simple configuration. Specifically, the reinforcing member 50, as well as being bent into an S-shape along the first to fourth bending lines 52a to 52d, is configured of a first plate piece 50a extending in an approximately horizontal direction, a second plate piece 50b bent in such a way as to stand approximately upright at a front end of the first plate piece 50a, a third plate piece 50c bent inward from an upper end of the second plate piece 50b and extending in the approximately horizontal direction, a fourth plate piece 50d bent approximately upright at a rear end of the third plate piece 50c, and a fifth plate piece 50e bent outward from an upper end of the fourth plate piece 50d and extending in the approximately horizontal direction.

The first plate piece 50a positioned on a lower end side is fixed by welding to a back plate 53 of which both ends are fixed to the frame 51, and a leading end of the fifth plate piece 50e positioned on an upper end side is fixed by welding to the lower end of the partition plate 6a. The bending formation extending in the spanning direction is not limited to the heretofore described one. It is sufficient that the reinforcing member 50 is formed bending at least once.

On the rear surface 18a of the lower front door (the second door) 18, a counter 55, protruding toward the opening 46 and extending in the horizontal direction, for counting the coins inserted from the coin slot 12, is provided above a roller 57. Then, a front end of the counter 55, when the lower front door 18 is in a closed state, enters an inside of a recessed portion 56 formed in a squared U-shape cross-section by the third plate piece 50c, the fourth plate piece 50d and the fifth plate piece 50e. Accordingly, even in the event that a wire is inserted from a bottom gap 58 between the upper front door 6 and the lower front door 18, as it is stopped by the counter 55, it being possible to stop an intrusion of the wire, it is possible to prevent a dishonest behavior of opening the doors with malicious intent and so on. Furthermore, as the roller 57 to be described hereafter is supported by the counter 55, when the lower front door 18 is in the closed state, it is possible to increase strength with respect also to a weight of the coin tray 19 and the lower front door 18.

Also, the fifth plate piece (an interruption portion) 50e bent toward the lower front door (the second door) 18 from the fourth plate piece 50d is provided at the upper end of the reinforcing member 50. By means of the interruption portion 50e, even in the event that the wire or the like is inserted from the gap 58, as the further intrusion of the wire is stopped, it is possible to prevent the dishonest behavior of opening the doors with malicious intent.

The second plate piece (a blocking portion) 50b extending in the spanning direction, being provided in a lower portion of the reinforcing member 50, is disposed in such a way as to make contact with the back plate 53. By means of the blocking portion 50b, even in the event that the wire or the like is inserted from the gap 58, as the further intrusion of the wire is stopped, it is possible to prevent the dishonest behavior of opening the doors with malicious intent and so on. Furthermore, as the first plate piece 50a is bonded to a lower portion 53b of the back plate 53, it being possible to stop the intrusion of the wire, it is possible to further strengthen a countermeasure to the dishonest behavior.

A tongue piece 53a extending in such a way as to overlap a bottom surface 18b of the lower front door 18 is provided at a lower end of the back plate 53. By means of the tongue piece 53a, even in the event that the wire or the like is inserted from the gap 58, as the further intrusion of the wire is stopped, it is possible to prevent the dishonest behavior of opening the doors with malicious intent and so on.

The roller 57, which serves as a protrusion, is attached to a left end of the counter 55, of which a lower end is spaced a predetermined distance apart from an upper end of the reinforcing member 50, in such a way as to be mounted on the reinforcing member 50 provided in a lower portion of the frame 51 on the peripheral edge of the opening 46 of the upper front door (the first door) 6, on a rear side of the lower front door (the second door) 18. Also, the roller 57 is positioned on an upper end side on a rear side of the coin tray 19 provided in a lower portion of the lower front door 18.

Therefore, when the lower front door 18 is in the closed position, the roller 57 is supported on the third plate piece 50c of the reinforcing member 50. Consequently, it is possible to disperse the weight of the coin tray 19 and the lower front door 18, and a load in a case in which the coins or the like are contained in the coin tray 19. Furthermore, by adopting the rotatable roller 57, as wear is reduced, it is possible to smoothly perform the opening and closing operation of the lower front door 18.

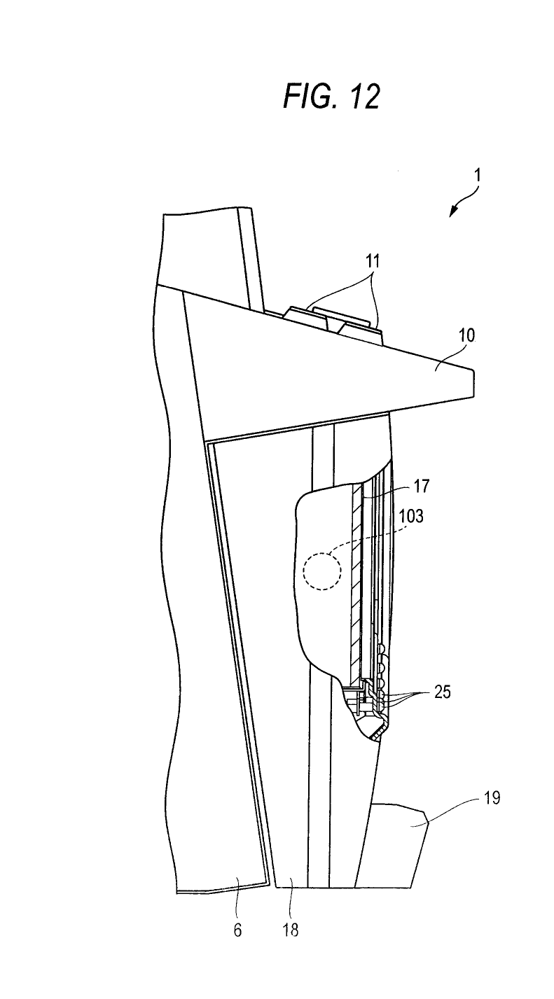

Furthermore, as shown in FIG. 12, the upper front door 6 is disposed inclined rearward, the belly panel (an effect portion) 17 is provided on a front surface of the lower front door 18, and an upper portion of the lower front door 18 protrudes forward of the upper front door 6. As the upper front door 6 is disposed inclined rearward, even when the upper front door 6 is opened, by means of the weight of the upper front door 6, it is possible to prevent a situation in which the upper front door 6 is abruptly fully opened. Furthermore, as the upper portion of the lower front door 18 protrudes forward of the upper front door 6, by positioning the lower front door 18 perpendicular to a cabinet bottom surface, as it is possible to make the belly panel 17, on which effect details are displayed, approximately perpendicular to the horizontal direction, it being possible to make the effect details on the belly panel 17 easily viewable even to a remote gallery, it is possible to secure a housing space on a rear surface of the lower front door 18.

The belly panel 17 on which the effect details are displayed is lit by light emitting means (for example, the cold-cathode tube, a fluorescent lamp, an LED lamp or the like) 103 disposed on the rear surface of the lower front door 18. The housing space provided on the rear surface of the lower front door 18, formed by protruding the upper portion of the lower front door 18 forward of the lower portion thereof, can be used as a radiation space of the cold cathode tube 103. It is also acceptable that the belly panel 17 on which the effect details are displayed is a liquid crystal panel or the like.

Operation Table, Belly panel and Under Lamps

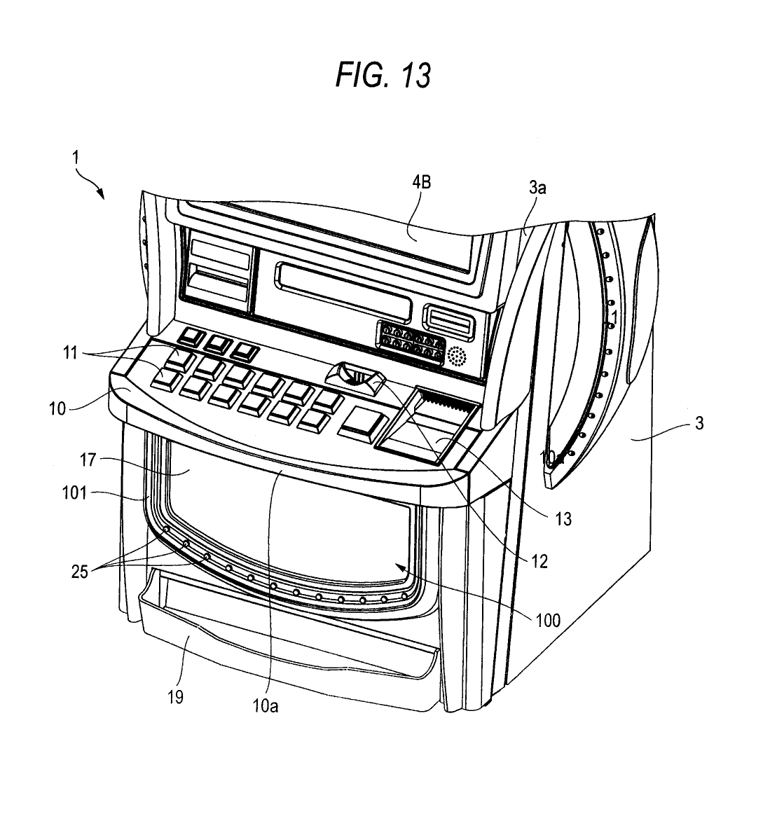

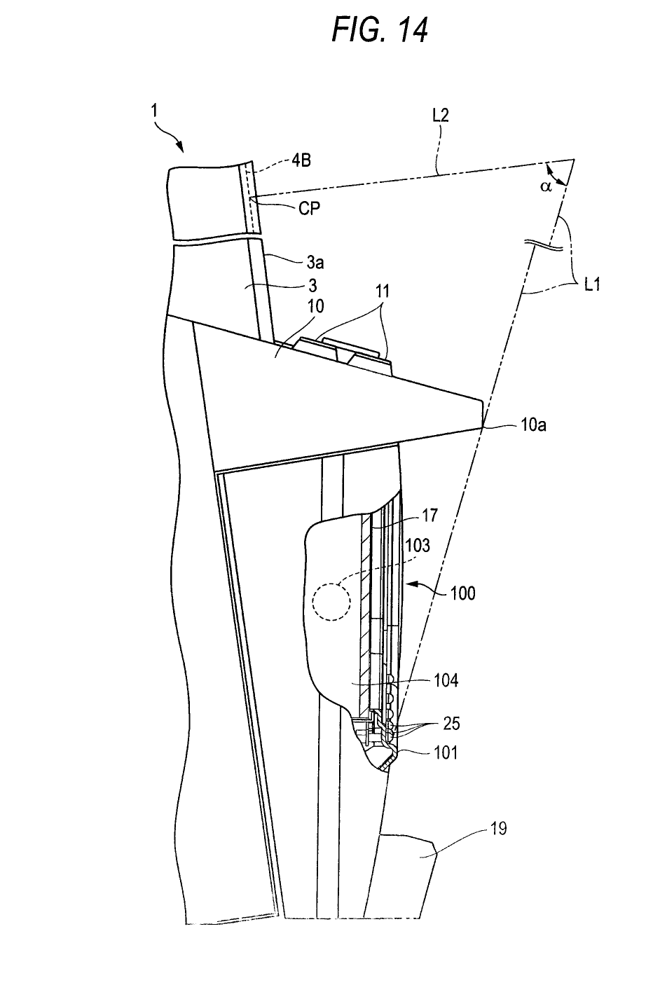

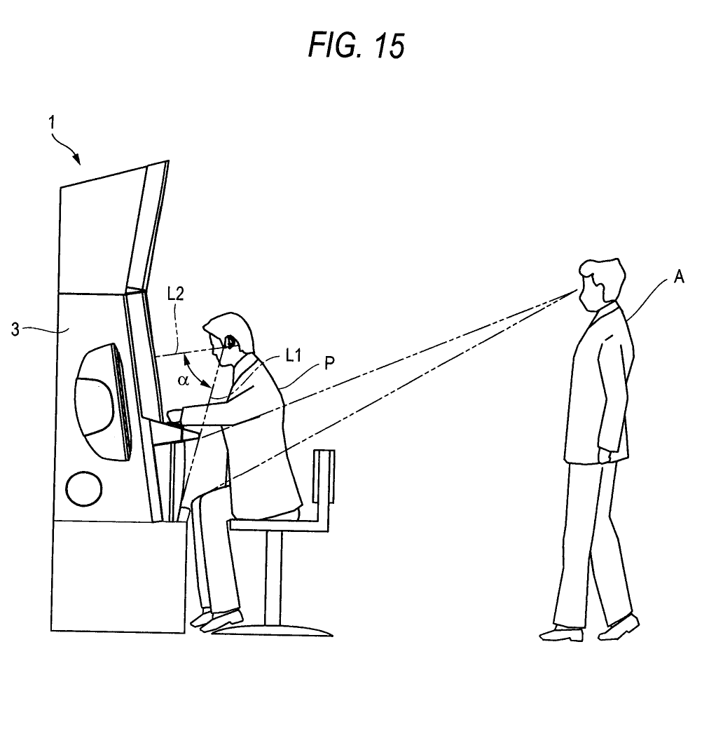

As shown in FIGS. 13 and 14, the operation table (a protruding portion) 10, being disposed on a front surface 3a of the cabinet 3, protrudes forward. An upper surface of the operation table 10, being inclined in such a way that a player P (refer to FIG. 15) side is lower than a cabinet 3 side, is designed in such a way that it is easy for the player P to put a hand on it and lean. Furthermore, on the operation table 10, the various operation buttons 11 are arranged as the operation unit instructing an execution of the game, and furthermore, the coin slot 12 and the bill slot 13 are provided.

An under display portion 100 is provided below the operation table 10 of the cabinet 3. The under display portion 100, being in a position set back from a front end 10a of the operation table 10, is configured of a frame 101 surrounding the belly panel 17 along an outer edge of the belly panel 17, a plurality of the under lamps (the light emitting units) 25 fixed to the frame 101 along the lower edge of the belly panel 17, and the fluorescent lamp 103 radiating light toward the belly panel 17 from a rear side of the belly panel 17.

The belly panel 17 is formed of a film, on which an image such as a logo showing an appellation of the gaming machine 1, a character or the like is displayed, and a transparent acrylic plate being layered. The belly panel 17, being disposed at a lower front of the cabinet 3, is positioned between a fluorescent lamp box 104 provided inside the cabinet 3 and the frame 101. A pair of right and left fluorescent lamp sockets is fixed to the fluorescent lamp box 104, and pins of the fluorescent lamp 103 are inserted in the fluorescent lamp sockets. Light emitted from the fluorescent lamp 103 is transmitted through the belly panel 17, highlighting an image such as the logo, the character or the like. As a result, it becoming easy for the image displayed on the belly panel 17 become visible to a gallery A watching a slot game from diagonally behind the player P, the gaming machine 1 is distinguished from another machine, improving the degree of advertising.

An inner side of the frame 101 close to the belly panel 17 is slightly more protuberant than an outer side thereof. The lower edge of the belly panel 17 curves gently, and a lower portion of the frame 101 also curves following a shape of the belly panel 17. In the lower portion, as well as on the inner side of the frame 101, the under lamps 25 are disposed along the lower edge of the belly panel 17. The under lamps 25, being full color LED's in which unitary LED elements capable of emitting light of three primary colors (red, blue and green) are combined, are fixed onto an LED substrate mounted with an LED drive circuit. The tray 19 accumulates the coins (the game media) that are paid out based on a result of the slot game, and is provided below the under lamps 25. The under lamps 25 illuminates the belly panel 17 from below and illuminates the tray 19 from above.

The under lamps 25 and the operation table 10 are disposed in such a way that an extended line L1 of a straight line connecting the under lamps 25 and the front end 10a of the operation table 10 forms an acute angle α with respect to a perpendicular line L2 from the middle display portion 4B passing through a center CP of the middle display portion 4B, as seen from a side of the cabinet 3.

As the player P plays the slot game focusing most closely on the middle display portion 4B, which displays an execution state of the slot game, an arrangement of the middle display portion 4B is determined in consideration of a sight line of the player P. As shown in FIG. 15, by disposing the under lamps 25 and the operation table 10 in the heretofore described way based on the arrangement of the middle display portion 4B, a part of the light emitted from the under lamps 25 toward the player P, being shielded by the operation table 10, becomes unlikely to reach the player P's eyes.

According to the gaming machine 1, by causing the under lamps 25 to flash, or emitting light of various colors, it is possible to advertise the gaming machine 1 to the gallery A diagonally behind the player P. Furthermore, even though the light is emitted from the under lamps 25 so as to advertise to the gallery A, as a part of the light is shielded by the operation table 10, it is unlikely to reach the player P's eyes. As a result, it being possible to balance the advertising to the player A by the light from the under lamps 25 with a reduction in the fatigue of the player P's eyes, it is possible to, while attracting the gallery A, allow the player P to concentrate on the game without imposing an excessive strain on the player P.

Furthermore, as the player P can perform an operation of the slot game while putting a hand on the operation table 10, even in the event that he or she plays the slot game in the same position for a long time, it is possible to reduce a physical fatigue of the player P during the slot game.

Furthermore, the under lamps 25 are disposed along the lower edge of the belly panel 17 in such a way as to light up the belly panel 17 (refer to FIGS. 13 and 14). As a result, the belly panel 17, as it is lit by the light emitted from the under lamps 25, becomes easily spotted by the gallery A. As a result, the attraction of the gallery A by means of the belly panel 17 is improved.

Furthermore, in the event that the arrangement of the middle display portion 4B displaying the game details is determined, it is possible to easily determine an arrangement relationship between the under lamps 25 and the operation table 10, and a dimension of the operation table 10 protruding forward from the cabinet 3. As a result, it is also possible to easily apply the arrangement and the dimension to other various models of gaming machines.

Furthermore, as the under lamps 25 are disposed above the tray 19, it is possible to increase a quantity of light around the tray 19.

Indirect Illumination

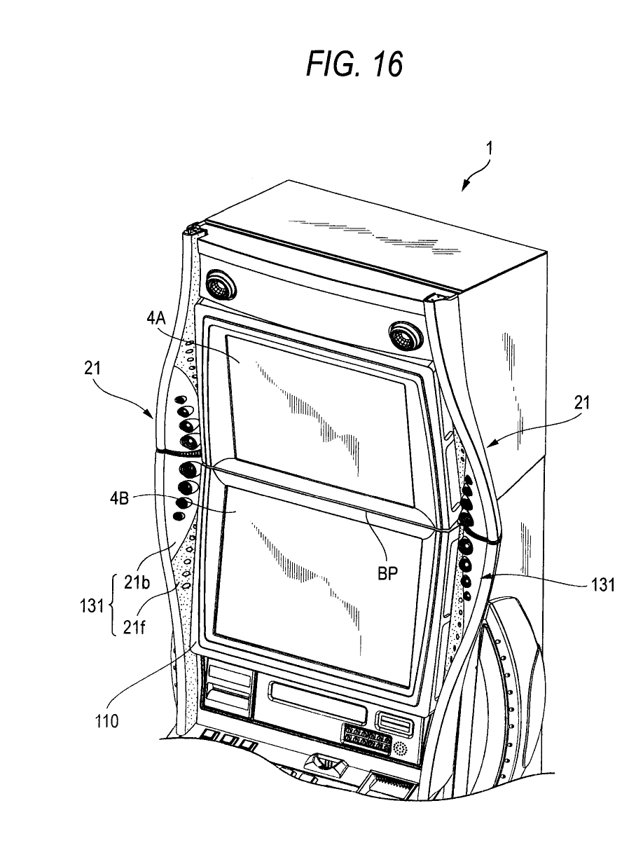

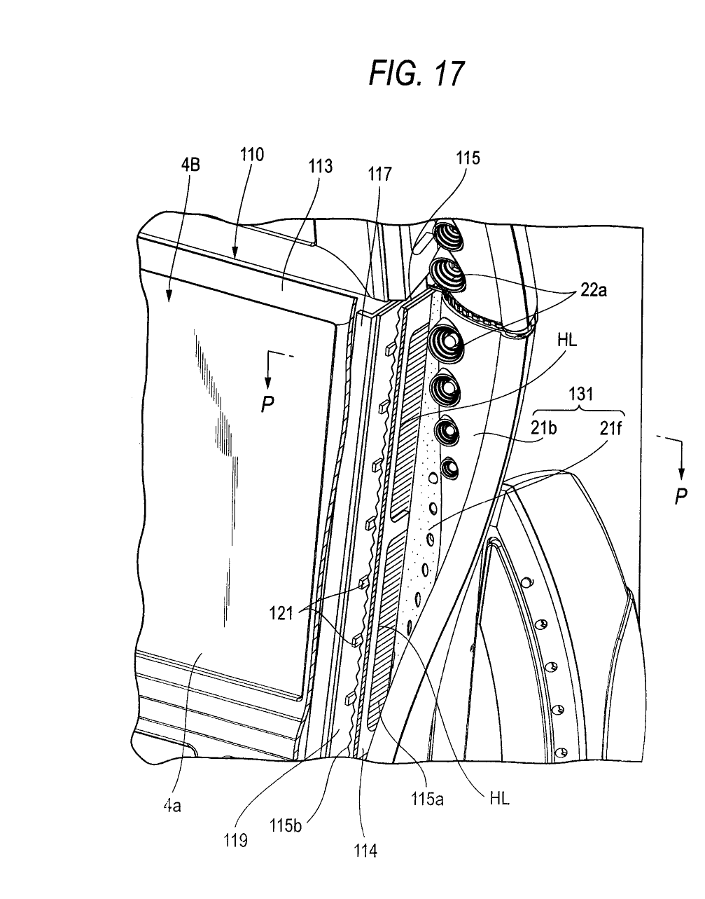

As shown in FIGS. 16 to 18, the middle display portion 4B includes the liquid crystal panel, and a rectangular peripheral frame 110 is fixed to a peripheral edge of the middle display portion 4B. The peripheral frame 110 is configured of a front light shielding plate 113, made of a resin, which is looped along a front surface FP2 of the middle display portion 4B, side light shielding plates 114, extending in the vertical direction along side edges of the front light shielding plate 113, which are fixed to right and left side portions of the front light shielding plate 113, and an acrylic transparent plate 115 adhering to a rear of each side light shielding plate 114. Two side light shielding plates 114, being perpendicular to the front light shielding plate 113, are each formed with notch holes HL, notched on a rear, arranged in the vertical direction. The transparent plate 115 has a flat outer surface 115a in contact with the side light shielding plate 114 and a corrugated inner surface 115b.

A bracket 117 extending in the vertical direction is provided on a rear side of the front light shielding plate 113, and an LED substrate 119 extending in the vertical direction in such a way as to face each transparent plate 115 is fixed to the bracket 117. The LED substrate 119, as well as being mounted with an LED drive circuit, is mounted with a plurality of full color LED's 121 in a longitudinal direction. The full color LED's 121 are configured by combining unitary LED elements capable of emitting light of three primary colors (red, blue and green). A part of the light emitted from the full color LED's 121 is shielded by the front light shielding plate 113 and the side light shielding plates 114, while the other light, after being refracted by the corrugated inner surfaces 115b of the transparent plates 115, is transmitted through the transparent plates 115, furthermore, passes through the notch holes HL, and is radiated toward sides of the peripheral frame 110.

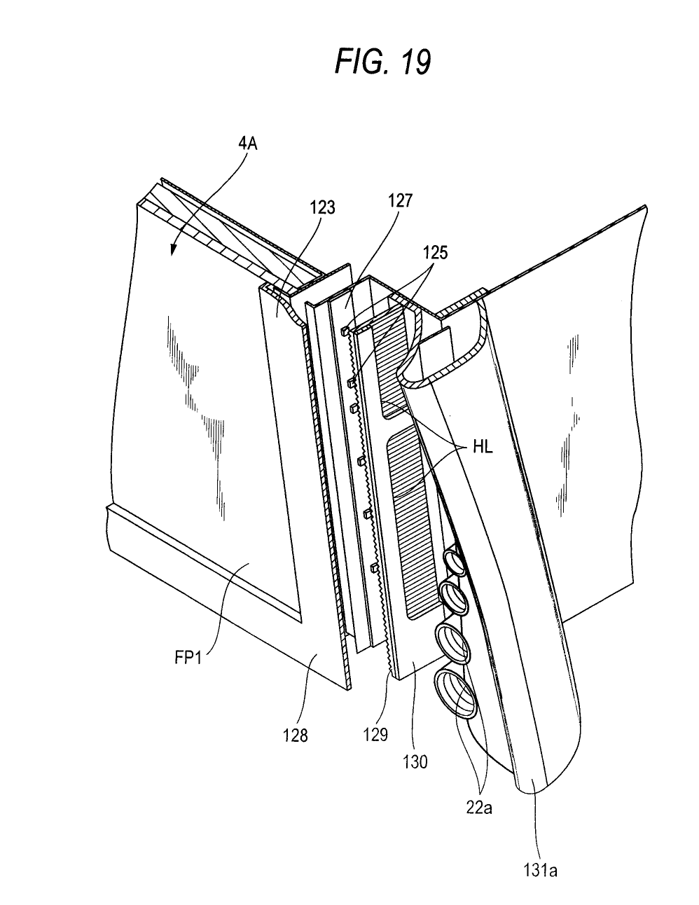

As shown in FIG. 19, the upper display portion 4A is also the liquid crystal panel in the same way as the middle display portion 4B, and a rectangular peripheral frame 123 is also fixed to a peripheral edge of the upper display portion 4A. An LED substrate 127 mounted with a plurality of full color LED's (a light emitting unit) 125 is disposed inside the peripheral frame 123. In the same way as the peripheral frame 110 surrounding the peripheral edge of the middle display portion 4B, the peripheral frame 123 having a front light shielding plate 128, side light shielding plates 130 and transparent plates 129, a part of light emitted from the full color LED's 125 is shielded by the front light shielding plate 128 and the side light shielding plates 130, and the other light, after being transmitted through the transparent plate 129, passes through notch holes HL, and is radiated toward sides of the peripheral frame 123.

As shown in FIGS. 16 to 19, the inclined portions 21 protruding bow-like laterally across a whole of the upper display portion 4A and the middle display portion 4B are formed in the right and left end portions of the cabinet 3. The inclined portions 21 each being configured of the inclined face 21a and the thick peripheral frame 21c, the reflecting face 21b made of a member, on which a resin is chrome-plated in such a way as to reflect the light, is formed on a part of the inclined face 21a and the thick peripheral frame 21c. Furthermore, a diffusely reflecting face 21f, of which a surface is satin finished to form a plurality of fine irregularities, is formed in the other area of the inclined portion 21a. A reflecting portion 131 is configured of the reflecting face 21b and the diffusely reflecting face 21f. The eight main side lamps 22a, being arranged in the vertical direction on the reflecting face 21b, decrease in size gradually toward the top or the bottom from the center.

The diffusely reflecting faces 21f and the reflecting faces 21b are planarly symmetrical across a vertically overlapping boundary surface BP (refer to FIG. 16) of the upper display portion 4A and the middle display portion 4B. Each diffusely reflecting face 21f is formed on an inner side close to the upper display portion 4A or the middle display portion 4B, while each reflecting face 21b is formed in a position, on an outer side far from the upper display portion 4A or the middle display portion 4B, closer to the boundary surface BP in the vertical direction. Furthermore, the diffusely reflecting face 21f increases in width as it goes away from a center of the inclined portion 21, while the reflecting face 21b decreases in width as it goes away from the center of the inclined portion 21.

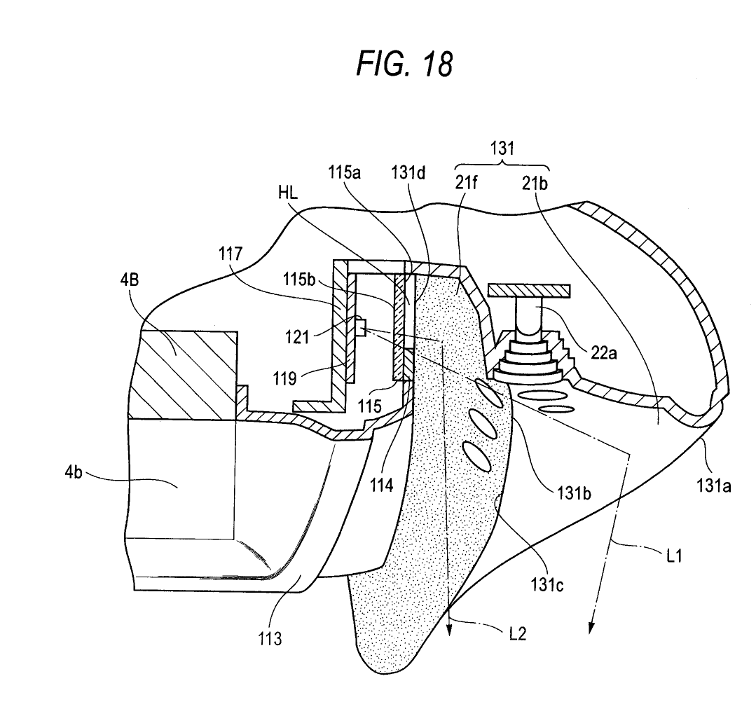

An outer end portion 131a (refer to FIGS. 18 and 19) of the reflecting face 21b is positioned in such a way as to be approximately in plane with the front surfaces 4a and 4b of the upper display portion 4A and the middle display portion 4B. An inner end portion 131b of the reflecting face 21b is in a position, posterior to the front surfaces 4a and 4b of the upper display portion 4A and the middle display portion 4B, closer to the upper display portion 4A and the middle display portion 4B than the outer end portion 131a. In this way, the outer end portion 131b of the reflecting face 21b being positioned rearward of the outer end portion 131a, the reflecting face 21b is inclined toward the upper display portion 4A and the middle display portion 4B detached rearward from the front surfaces 4a and 4b of the upper display portion 4A and the middle display portion 4B.

An outer end portion 131c of the diffusely reflecting face 21f is continuous with the inner end portion 131b of the reflecting face 21b, and furthermore, the transparent plates 115 and 129 are fixed to an inner end portion 131d of the diffusely reflecting face 21f. The diffusely reflecting face 21f is inclined in such a way that the inner end portion 131d is in a position posterior to the outer end portion 131c, and is in a position closer to the upper display portion 4A and the middle display portion 4B.

In the gaming machine 1, a light effect is performed by causing the full color LED's 121 and 125 inside the peripheral frames 110 and 123 to flash, or emit light of various colors. A part of the light emitted from the full color LED's 121 and 125, being shielded by the front light shielding plates 113 and 128 and side light shielding plates 114 and 130 of the peripheral frames 110 and 123, is unlikely to reach the player's eyes. The other light, after being transmitted through the transparent plates 115 and 129, passes through the notch holes HL, and is reflected by the reflecting portions 131 of the inclined portions 21. Reflected beams of light L1 and L2 are visible to the gallery watching the slot game from diagonally behind the player, improving the advertising of the gaming machine 1.

In the gaming machine 1, as the full color LED's 121 and 125 are disposed on a farther inside the cabinet 3 than the front surfaces 4a and 4b of the upper display portion 4A and the middle display portion 4B, it is difficult for the full color LED's 121 and 125 to be visible to the player. The quantity of the light reflected off the reflecting face 131, configured of the light-reflecting member, is more suppressed than that of the light radiated from the full color LED's 121 and 125, reducing the strain on the player's eyes. As a result, the effect due to the light from the full color LED's 121 and 125 becomes possible while reducing the strain on the player's eyes. As the full color LED's 121 and 125 are disposed on the inner side of the cabinet 3, it does not happen that the full color LED's 121 and 125 are damaged by being touched by the player.

The diffusely reflecting faces 21f being formed in the reflecting portions 131 of the inclined portions 21, the quantity of the light L2 reflected off the diffusely reflecting face 21f is more suppressed than that of the light L1 reflected off the reflecting face 21b. For that reason, a glare which the player feels is reduced, making it easier to allow the player to concentrate on the game.

Furthermore, the reflecting portions 131 are disposed along the right and left peripheral edges of the upper display portion 4A and the middle display portion 4B. The player and the surrounding galleries are focusing most closely on the upper display portion 4A and the middle display portion 4B, on which are displayed the information relating to the game. The right and left side edges of the upper display portion 4A and the middle display portion 4B facing the places in which the reflecting portions 131 are disposed, the quantity of light in the vicinity of the side edges of the upper display portion 4A and the middle display portion 4B is increased by the lights L1 and L2 reflected off the reflecting portions 131. As a result, the upper display portion 4A and the middle display portion 4B being accentuated, it is possible to improve the attraction of the galleries to the gaming machine 1 while suppressing the strain on the player's eyes.

Furthermore, the full color LED's 121 and 125, being disposed inside the peripheral frames 110 and 123 and in such a way as to face the reflecting portions 131, are contiguous with the upper display portion 4A and the middle display portion 4B. The upper display portion 4A, the middle display portion 4B and the full color LED's 121 and 125 receiving a power supply from a common power source, by the full color LED's 121 and 125 coming near to the upper display portion 4A and the middle display portion 4B, the wiring therebetween becomes easier. By the full color LED's 121 and 125 being disposed inside the peripheral frames 110 and 123, the upper display portion 4A and the middle display portion 4B are also accentuated by light leaking from the peripheral frames 110 and 123, enabling the improvement in the degree of advertising of the gaming machine 1.

The reflecting faces 21b of the reflecting portions 131 are disposed on right and left sides of the upper display portion 4A and the middle display portion 4B. The reflecting portions 21b are inclined toward the upper display portion 4A and the middle display portion 4B as they go away from the front surfaces 4a and 4b of the upper display portion 4A and the middle display portion 4B toward a rear of the cabinet 3. As a result, it becomes easy for the light L1 reflected by the reflecting faces 21b to reach the eyes of the gallery positioned diagonally behind the player, improving the degree of advertising to the gallery while suppressing the strain on the player's eyes.

External Display Device

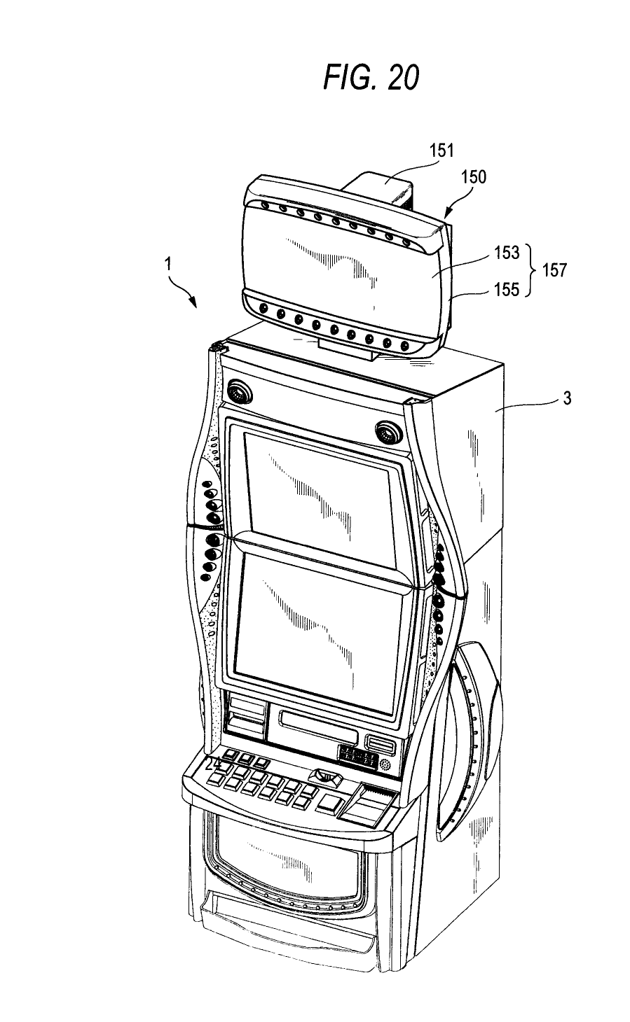

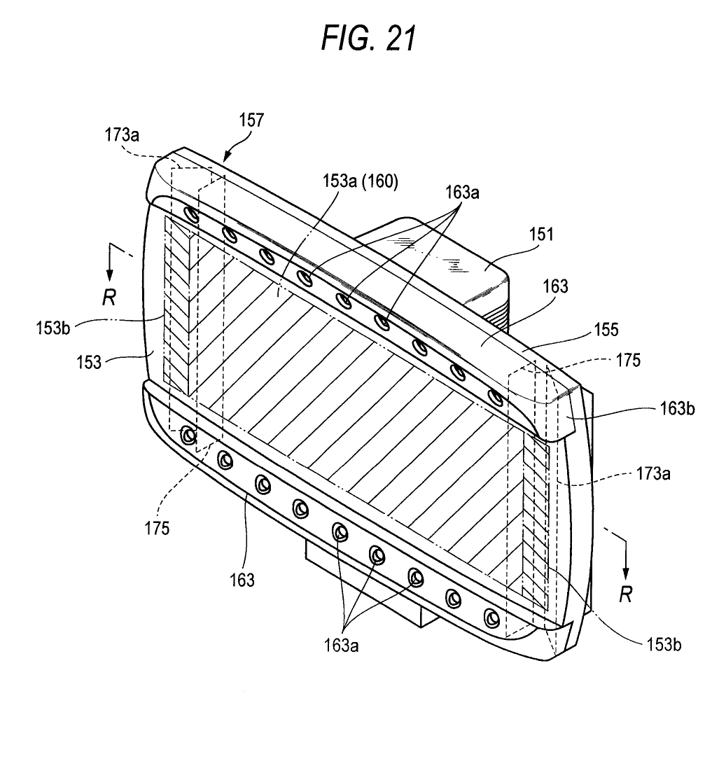

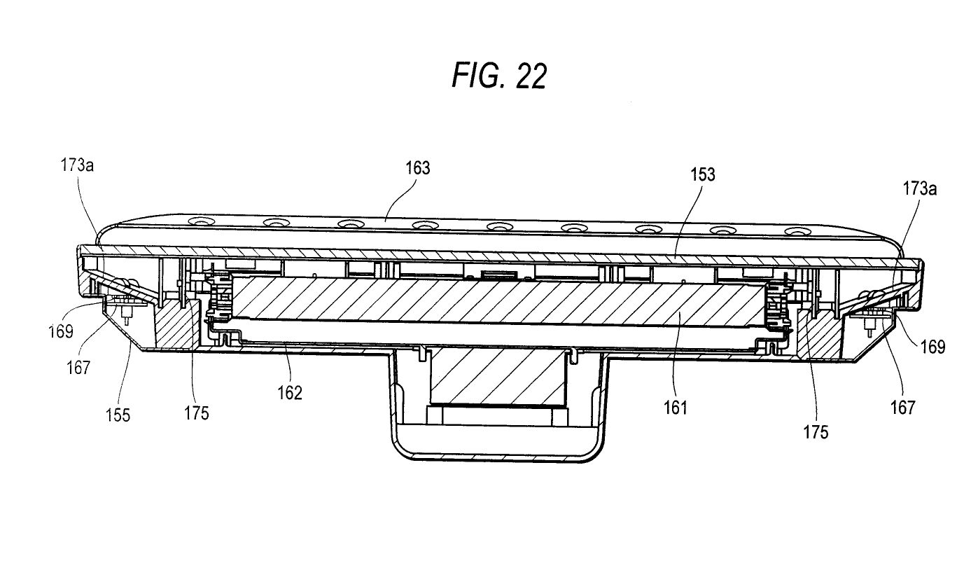

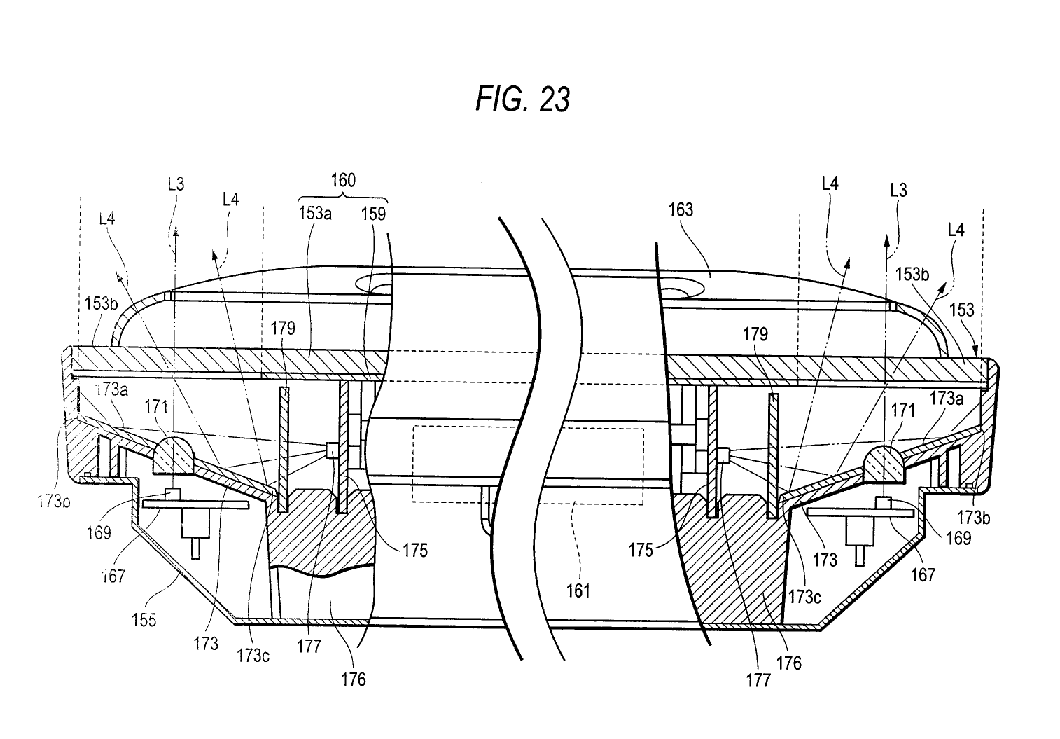

As shown in FIG. 20, an external display device 150 is fixed to an upper end of the cabinet 3 of the gaming machine 1 via a support 151. The external display device 150, as shown in FIGS. 21 to 23, has a casing (a cabinet) 157 configured of a transparent acrylic plate 153 on a front and an opaque rear cover 155 on a rear. A film 159 (refer to FIG. 23), on which is displayed a logo showing an appellation of the slot game or a character image, is disposed on a rear of the acrylic plate 153 and in an approximate center of the acrylic plate 153. A fluorescent lamp box 162 (refer to FIG. 22) housing a fluorescent lamp 161 is furnished rearward of the film 159. The film 159 is fixed sandwiched between the acrylic plate 153 and the fluorescent lamp box 162. A display portion 160, which displays the information relating to the game, is configured of a central portion 153a of the acrylic plate 153 overlapping the film 159, and the film 159. Light radiated from the fluorescent lamp 161 is transmitted through the display portion 160, causing the image displayed on the film 159 to stand out.

An LED unit 163 extending along an upper edge of the acrylic plate 153 is fixed to an upper portion of the display device casing 157. The LED unit 163, as well as being chrome-plated, has a horizontally long casing 163b, on a front surface of which is mounted a plurality of lens bodies 163a, an LED substrate, which is housed in the casing 163b and extends in a longitudinal direction of the casing 163b, and a plurality of white LED's mounted on the LED substrate. A similar LED unit 163 is also provided in a lower portion of the display device casing 157. White light L3 emitted from the white LED's in the LED unit 163 is transmitted through the lens bodies 163a, and radiated forward.

LED substrates 167 (refer to FIGS. 22 and 23) extending in the vertical direction are fixed to right and left side portions of the rear cover 155, and a plurality of white LED's 169 facing forward are mounted on each LED substrate 167. An oblique light portion 173 mounted with a plurality of lens bodies 171 in a longitudinal direction of each LED substrate 167 is provided between the LED substrate 167 and the acrylic plate 153. The white light L3 emitted from the white LED's 169 is transmitted through the lens bodies 171 of the oblique light portion 173 and the acrylic plate 153, and radiated forward. Furthermore, a reflecting face 173a, on which a resin is chrome-plated in such a way as to be able to reflect the light, is formed on a front surface of the oblique light portion 173. The reflecting face 173a, as well as facing the acrylic plate 153, is inclined in such a way that an outer end 173b on a side far from the display portion 160 is close to the acrylic plate 153, and an inner end 173c is far from the acrylic plate 153.

LED substrates 175 extending in the vertical direction are disposed closer to a center than the right and left oblique light portions 173, and on a rear side of the display portion 160. The LED substrates 175 are fixed to a plate-like bracket 176. The bracket 176, being fixed to an inner wall surface of the rear cover 155, protrudes forward from the inner wall surface of the rear cover 155. A plurality of full color LED's (light emitting units) 177, facing toward the reflecting face 173a of each oblique light portion 173, are mounted on each LED substrate 175. Translucent lacteous plates 179 are each fixed to the bracket 176, between the LED substrate 175 and the reflecting face 173a. Light emitted from the full color LED's 177, after being transmitted through the lacteous plates 179, is reflected by the reflecting faces 173a. Light L4 reflected off the reflecting faces 173a is transmitted through right and left end portions 153b of the acrylic plate 153, and radiated forward.

In the external display device 150, as the full color LED's 177 are disposed inside the display device casing 157, it is difficult for them to be visible to the player. The quantity of the light L4 reflected from the reflecting faces 173a being more suppressed than that of the light radiated from the full color LED's 177, the strain on the player's eyes is reduced. As a result, an effect due to the light from the full color LED's 177 becomes possible while reducing the fatigue of the player's eyes. As the full color LED's 177 are disposed in the display device casing 157, it does not happen that the player touches and breaks the full color LED's 177.

The reflecting faces 173a are disposed along side edges of the display portion 160 which displays the information relating to the game. A player, who plans to determine which of a plurality of gaming machines installed in an game arcade or a casino, tends to focus on not only the middle display portion 4B and the upper display portion 4A of the gaming machine 1, but also the display portion 160 of the external display device 150. As the right and left side edges of the display portion 160 face places in which the reflecting faces 173a are disposed, a quantity of light in a vicinity of the side edges of the display portion 160 is increased by the light L4 reflected off the reflecting faces 173a, and the display portion 160 is accentuated, so it is possible to improve the attraction of the gallery to the gaming machine 1 while suppressing the strain on the player's eyes.

The reflecting faces 173a are inclined more toward the display portion 160 as the reflecting faces 173a are away from the acrylic plate 153 to the backside, the acrylic plate 153 being disposed on the front side of the display device casing 157. As a result, it becomes easy for the light L4 reflected by the reflecting faces 173a to reach the eyes of the gallery positioned diagonally behind the player, improving the degree of advertising to the gallery while suppressing the strain on the player's eyes.

Speakers As shown in FIG. 3, between the middle display portion 4B and the operation table 10, laterally protruding speakers 23A and 23B are provided respectively on both right and left side surfaces of the cabinet 3. The speakers 23A and 23B serve as an effect producing device that produces an audial/visual effect related to the game. The speaker 23A is installed on the right side surface of the cabinet 3, while the speaker 23B is installed on the left side surface of the cabinet 3. The speaker 23A is disposed in an area which appears rearward of the laterally opening front door (the opening and closing door) 6 when the front door 6 is in an opened state in which it protrudes in a lateral direction of the cabinet 3.

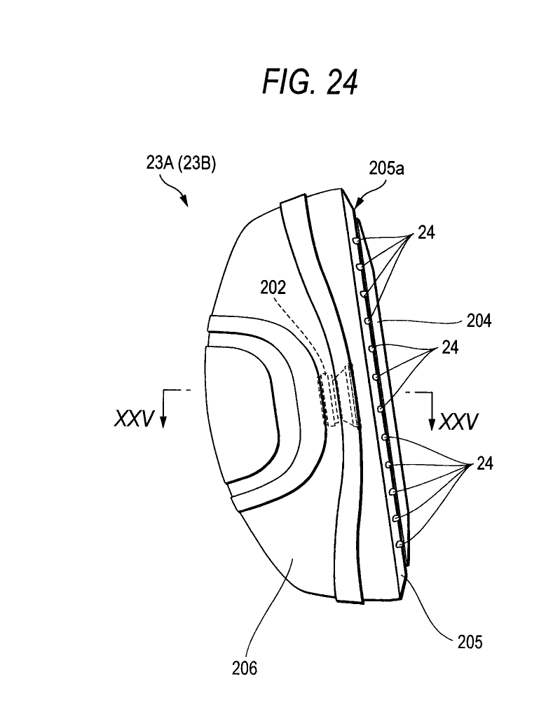

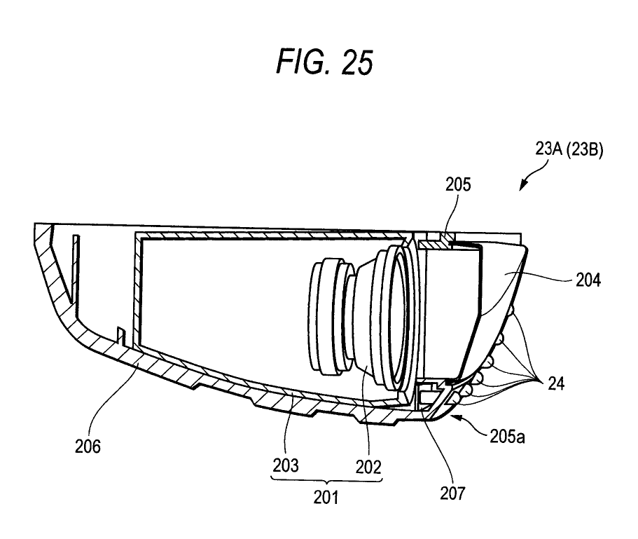

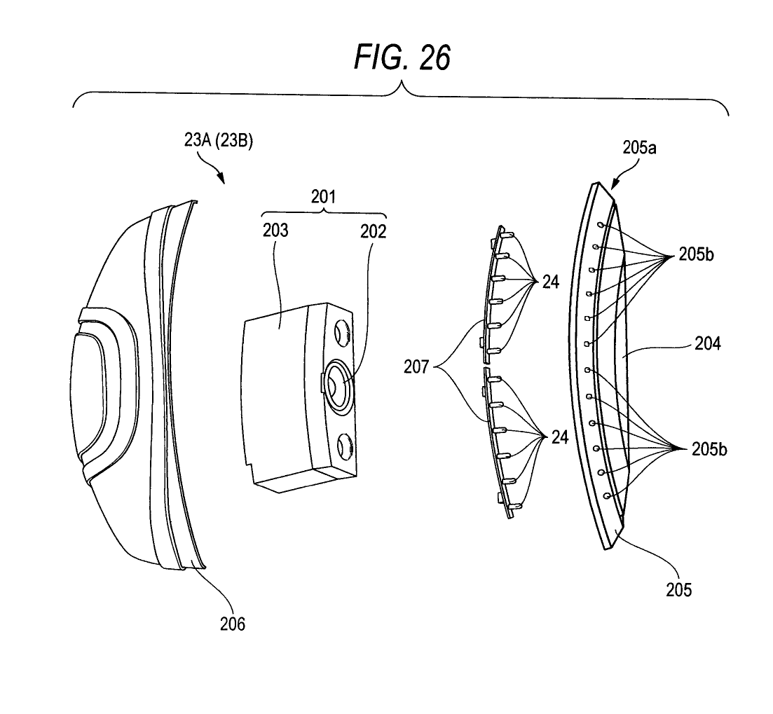

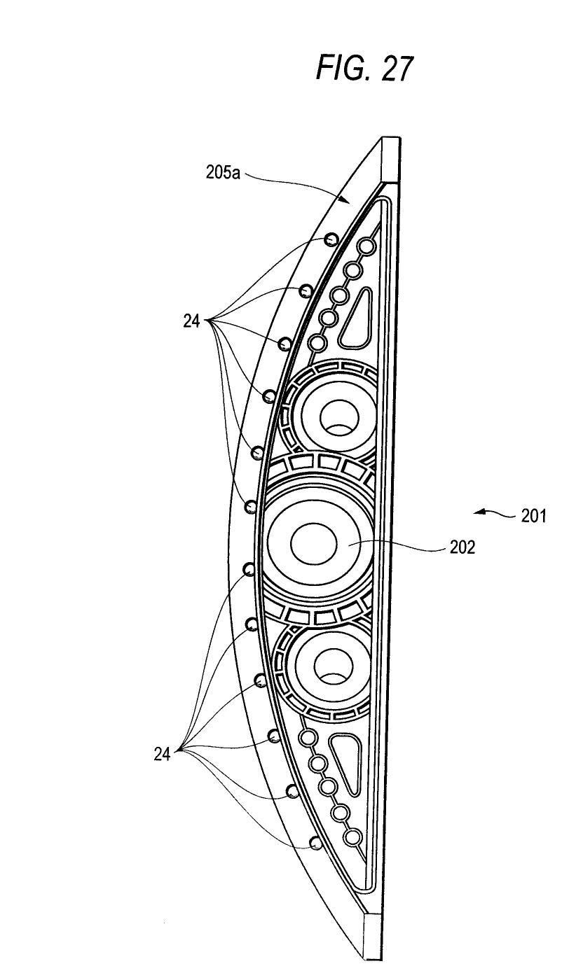

FIG. 24 is an enlarged side view showing the speaker in FIG. 2. FIG. 25 is a sectional view along line XXV-XXV shown in FIG. 24. FIG. 26 is an exploded perspective view of the speaker shown in FIG. 24. FIG. 27 is a front view showing the speaker in a state in which a net is removed.

The speakers 23A and 23B is formed in a bow shape protruding laterally as shown in FIGS. 25 to 27. A speaker box 201 that outputs a sound is disposed in each speaker 23A and 23B. The speaker box 201 includes a speaker unit 202 and a speaker cabinet 203 housing the speaker unit 202. The speaker unit 202 has a front surface fixed to a front wall of the speaker cabinet 203, and the speaker cabinet 203 is fixed to each side surface of the cabinet 3.

The speaker unit 202 is disposed at a height equivalent to or greater than that of the operation table 10 and equivalent to or less than that of the middle display portion 4B. The speakers 23A and 23B are inclined in such a way that upper portions tilt rearward, and the speaker units 202 in the speakers 23A and 23B are disposed in such a way that front surfaces of the speaker units 202 are parallel to the front surface of the middle display portion 4B. In this way, by inclining the speaker units 202 diagonally upward, and directing the sound emitted from the speaker units 202 toward the player, it is possible to improve a sound effect for the player.

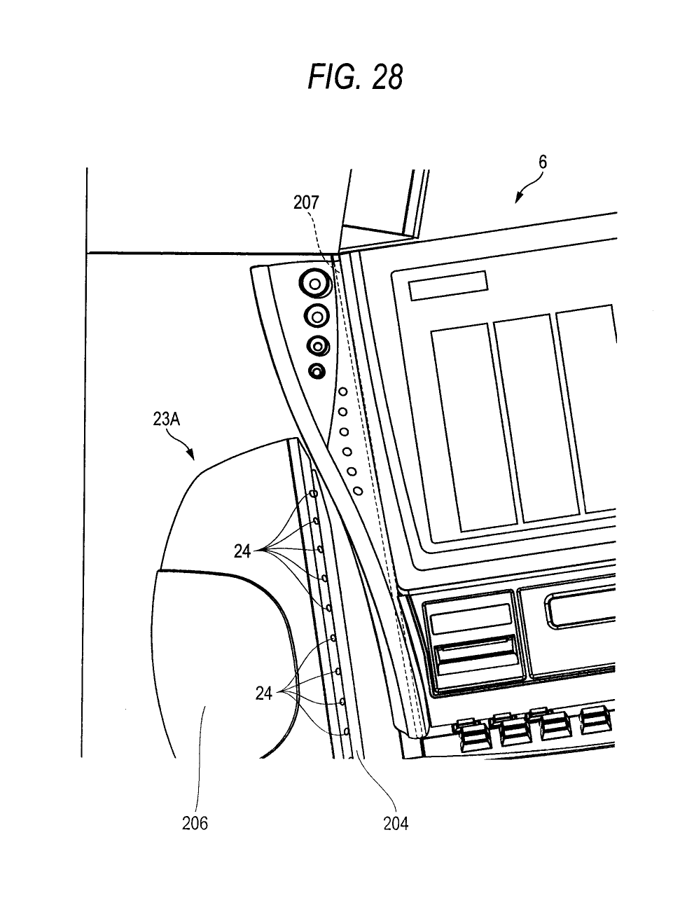

FIG. 28 is a right side view showing a state in which the front door is opened. The front door 6, which can pivot in the approximately horizontal direction via a hinge 207 extending in an approximately vertical direction, and open and close, is provided on the front surface of the cabinet 3, and the speaker 23A is disposed rearward of the hinge 207. Specifically, the speaker 23A is disposed in a position in which the speaker 23A does not interfere with the front door 6 when opening the front door 6. Accordingly, even in a case in which the front door 6 is fully opened, as it is possible to avoid a contact of the front door 6 with the speaker 23A, it is possible to prevent damage due to a hitting of the front door 6 against the speaker 23A.

The speakers 23A and 23B, as shown in FIGS. 24 to 27, each further include a net 204 covering a front face of the speaker box 201, a frame 205 to which the net 204 is fixed, and a rear side portion cover 206 covering a side face and a rear surface of the speaker box 201. The net 204 is fixed to a front end portion of the rear side portion cover 206 via the frame 205, and the frame 205 and the rear side portion cover 206 are attached to each side face of the cabinet 3.

The frame 205, configuring a peripheral portion of the front face of each speaker 23A and 23B, is disposed at a front of the speaker box 201. Also, an outer peripheral portion (a corner portion) of the frame 205 forms an inclined face 205a inclined with respect to each side surface of the cabinet 3. The inclined face 205a extends in such a way as to go away from each side surface of the cabinet 3 diagonally behind the cabinet. That is, the inclined face 205a forms an inclined face facing diagonally forward.

Openings 205b (refer to FIG. 26) for exposing the speaker lamps (light sources) 24 are formed in the inclined face 205a of the frame 205. One of the heretofore described light emitting units 20 is disposed in the outer peripheral portion of the front surface of each speaker 23A and 23B. The light emitting unit 20 has the inclined face 205a and the speaker lamps 24.

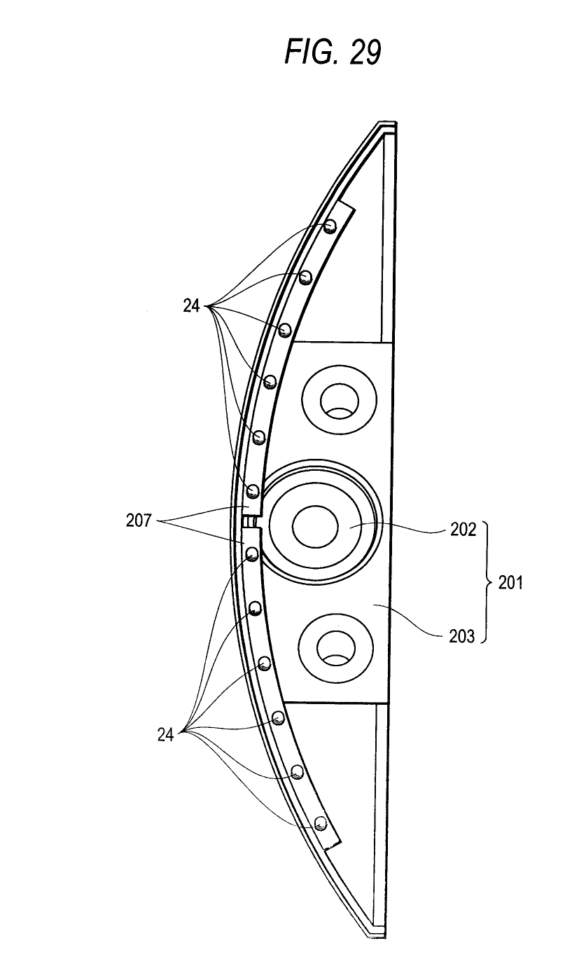

The speaker lamps 24 are fixed onto the substrate 207 as shown in FIGS. 25 and 26, and are disposed in the vertical direction along the outer peripheral portion of each speaker 23A and 23B. FIG. 29 is a front view showing an arrangement of the speaker box, the substrate and the speaker lamps in the speaker. The substrate 207, as shown in FIG. 29, is fixed to the front of the speaker box 201. Some of the speaker lamps 24 are disposed in a position overlapping the speaker box 201, in the front view. Accordingly, it is possible to reduce a widthwise size of the gaming machine 1.

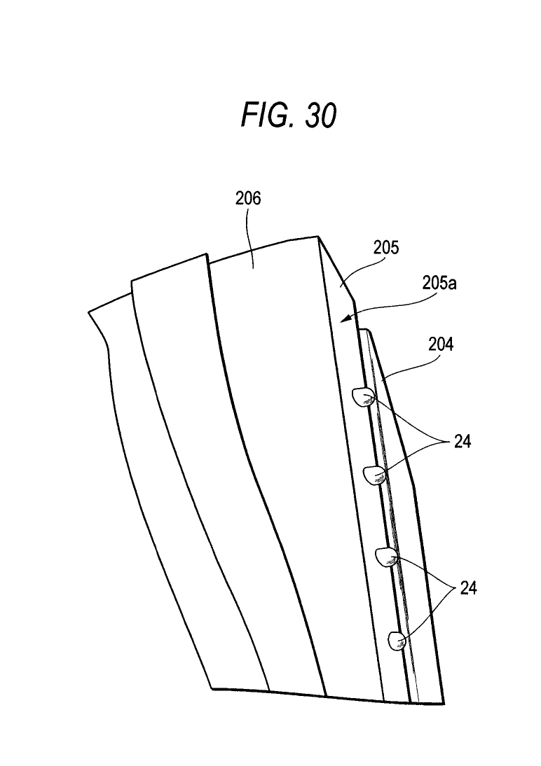

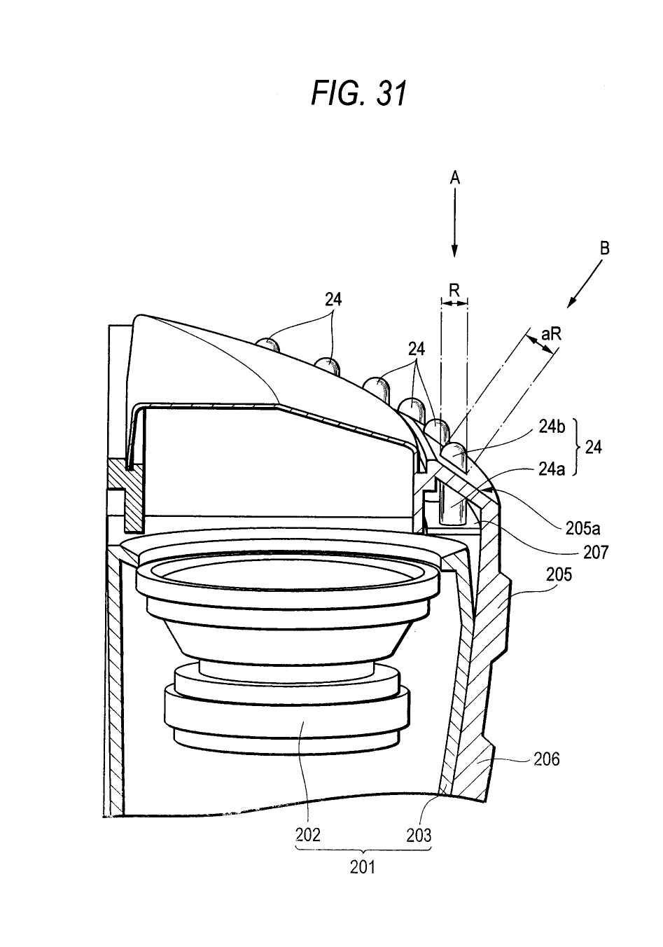

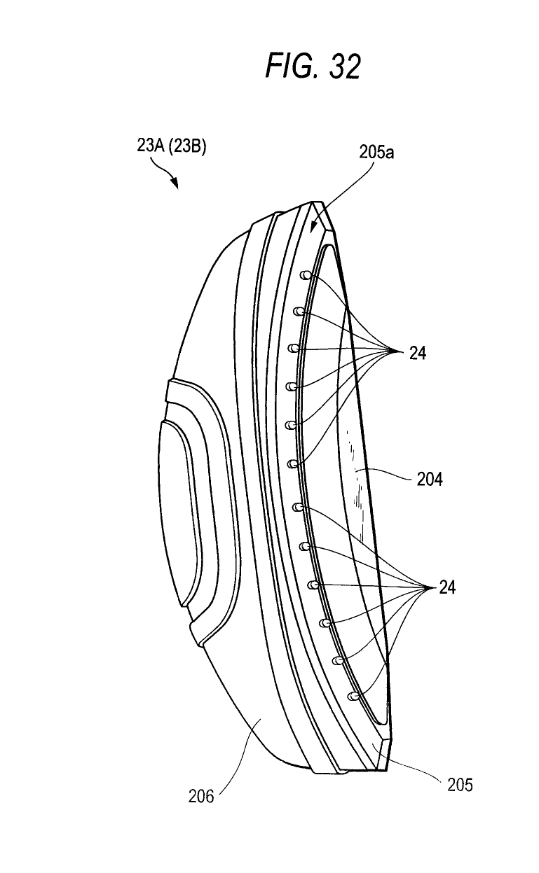

FIG. 30 is an enlarged side view showing the inclined face and the speaker lamps, FIG. 31 is an enlarged sectional view showing the inclined face and the speaker lamps, and FIG. 32 is a perspective view showing the speaker shown in FIG. 24 from a direction facing the inclined face. Each speaker lamp 24, as shown in FIG. 31, having a cylindrical body 24a, is disposed in such a way that an axial direction of the cylindrical body 24a follows a front and rear direction of the cabinet 3. A leading end 24b of each speaker lamp 24 is formed in a spherical shape.

The substrate 207 being fixed to an outer edge of a front surface of the speaker cabinet 203, a main surface of the substrate 207 faces toward the front of the cabinet 3. As shown in FIGS. 30 to 32, the speaker lamps 24 are placed in a state in which they protrude forward from the inclined face 205a. That is, an axis of each speaker lamp 24 and the inclined face 205a intersect at a predetermined angle, and apart of each cylindrical body 24a, and the leading ends 24b, are exposed from the inclined face 205a.

Next, a description will be given of a visibility of the speaker lamps 24 in a case in which the gaming machine 1 is viewed by the galleries around the gaming machine 1. As shown in FIG. 31, when the speaker lamps 24 are viewed from a front of the gaming machine 1 (from direction shown by an arrow A in FIG. 31), a size of a light emitting range of each speaker lamp 24 looks approximately the same as a size of a diameter R of the speaker lamps 24. In a case when the speaker lamps 24 are viewed from diagonal direction, specifically, from a direction (which is shown by an arrow B in FIG. 31) facing the inclined face 205a, the size of the light emitting range of each speaker lamp 24 becomes a R, which is larger than the diameter R of the speaker lamps 24. Accordingly, as it becomes easy for the gallery in a position approximately facing the inclined face 205a to focus on the speaker lamps 24, it is possible to attract the galleries to the gaming machine 1.

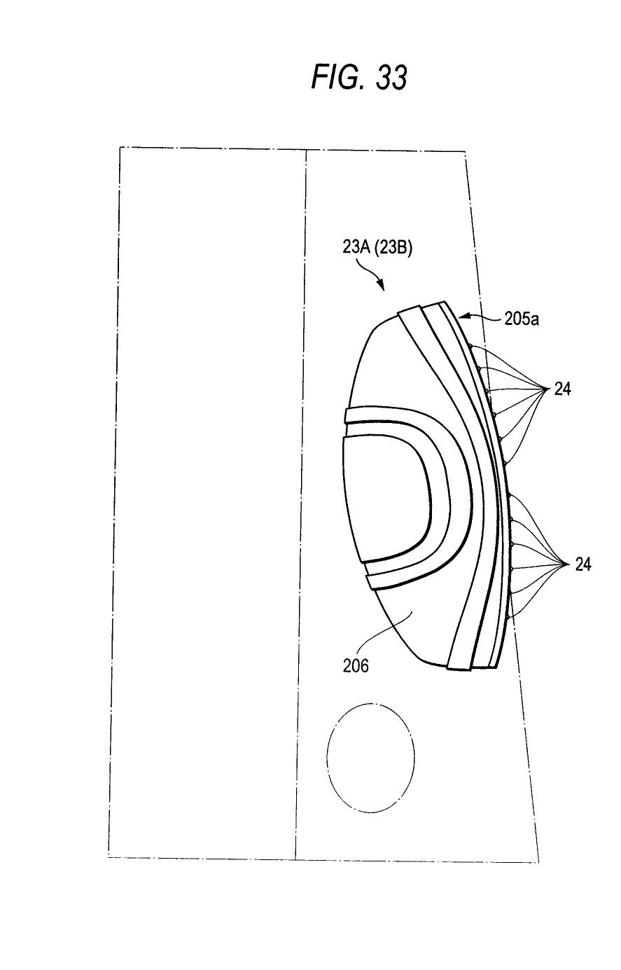

FIG. 33 is a perspective view showing the speaker shown in FIG. 24 from diagonally behind the gaming machine 1. A front outer corner portion of each speaker 23A and 23B forming the inclined face 205a inclined rearward, as the speaker lamps 24 are disposed on the inclined face 205a, it is possible to see the speaker lamps 24 from diagonally behind the gaming machine 1. In this way, it being possible to widen a range in which the light from the speaker lamps 24 can be seen, diagonally behind the gaming machine 1, it is possible to enhance the degree of attraction of gallery to the gaming machine 1 diagonally behind the gaming machine 1.

In the gaming machine 1 according to the embodiment, as the speaker 23A is disposed in the area posterior to the front door 6 which appears when the front door 6 is put in the opened state and projects in the lateral direction of the cabinet 3, it is possible to, while improving the sound effect, make efficient use of an open space between cabinets of adjacent gaming machines 1. Although the gaming machine 1 is configured in such a way as to include the speaker 23A as an effect producing device, it is also acceptable to configure a gaming machine include other effect producing devices such as, for example, a light emitting device or a monitor. It is also acceptable that the front door 6 is one which pivots in the approximately horizontal direction, or one which slides in the approximately horizontal direction.

The gaming machine 1 is configured to include the middle display portion 4B that is disposed on the front surface of the cabinet 3 and displays the information relating to the game, and the operation table 10 that is disposed on the front surface of the cabinet 3 and provided with the operation unit that allows the player to input commands for playing the game. The middle display portion 4B is disposed above the operation table 10, and the speaker units 202 are disposed at the height equivalent to or greater than that of the operation table 10 and equivalent to or less than that of the middle display portion 4B. According to this configuration, it is possible to arrange the speaker units 202 in a vicinity of the player, and to further improve acoustic effects output to the player.

The middle display portion 4B is disposed to be inclined to tilt rearward toward the player, and is disposed in such a way that the front surfaces of the speaker units 202 are parallel to the front surface of the middle display portion 4B. By inclining the middle display portion 4B diagonally upward and to face toward the player, the player can see the display portion from a comfortable position. Furthermore, by disposing the speaker units in such a way as to be parallel to the middle display portion 4B and to face the player, it is possible to further improve the acoustic effect output to the player.

As the gaming machine 1 includes the speakers 23A and 23B as the effect devices, it is possible to perform an effect by means of the sound output from the speaker boxes 201 in the speakers 23A and 23B. Also, as the effect producing devices disposed lateral to the cabinet 3 are used as the speaker boxes 210, unlike a case of a light effect due to the light emitting device or an image effect using the monitor, the player, without needing to move his or her sight line in order to look at the laterally disposed effect devices, can concentrate on the game.

As the speaker boxes 201 are provided on both right and left side surfaces of the cabinet 3, a distance between the speaker boxes 201 can be widened in comparison with a hitherto known one and, as well as it being possible to improve a sound effect such as a stereo effect due to the speaker boxes 201 (particularly, the speaker units 202) or a surround effect, it is possible to make effective use of open spaces on both sides in a right and left direction of the cabinet 3.

According to the gaming machine 1, as the middle display portion 4B is disposed on the front surface of the cabinet 3, and the speaker lamps 24 are installed on the side surfaces of the cabinet 3, without the light from the speaker lamps 24 impeding the game of the player, it is possible to attract the galleries around the gaming machine 1 to the gaming machine 1.

The speaker lamps 24 are installed in such a way as to protrude forward from the inclined faces 205a inclined with respect to the side surfaces of the cabinet 3 and to face diagonally forward. According to this configuration, the light emitting units of the speaker lamps 24 look wider when viewed at the speaker lamps 24 from a position which is diagonally in front of the cabinet 3 and approximately faces the inclined faces 205a, than when viewing at the speaker lamps 24 from in front of the cabinet 3. As a result, as it becomes easy for the gallery in the position approximately facing the inclined faces 205a to focus on the speaker lamps 24, it is possible to improve the effect of attraction of the galleries to the gaming machine 1.

As the speaker lamps 24 are installed at predetermined intervals from a lateral end of the middle display portion 4B, as well as it becoming more difficult for the light from the speaker lamps 24 to be visible to the player, it is possible to further improve the effect of attraction of the galleries watching the gaming machine 1 from afar to the gaming machine 1.

As the speaker lamps 24 are disposed at the height equivalent to or greater than that of the operation table 10 and equivalent to or less than that of the middle display portion 4B, by disposing the middle display portion 4B and the speaker lamps 24 at the same height as the sight line of the gallery, it is possible to immediately focus the sight line of the gallery focusing on the speaker lamps 24 on the middle display portion 4B. Also, by disposing the speaker lamps 24 in such a way as to be parallel to the middle display portion 4B, it is possible to immediately focus the sight line of the gallery focusing on the speaker lamps 24 on the middle display portion 4B.

The speaker lamps 24 are disposed on the front surfaces of the speaker boxes 201 protruding laterally from the side surfaces of the cabinet 3. That is, the speaker lamps 24 are disposed in the position overlapping the speaker boxes 201, in the front view. Accordingly, it is possible to reduce the width in the lateral direction of the gaming machine 1. For example, even in a case of increasing a diameter of the speaker units 202 in the speaker boxes 201 in order to eliminate a lack of low-pitched sound production and improve a sound quality, it is possible to reduce the width in the lateral direction of the gaming machine 1.

Although some of the speaker lamps 24 and the speaker units 202 are disposed in a height position equivalent to or higher than the operation table 10 and equivalent to or lower than the variable display position 4B, it is also acceptable to dispose the speaker lamps 24 and the speaker units 202 in another height position.

Top Lamp

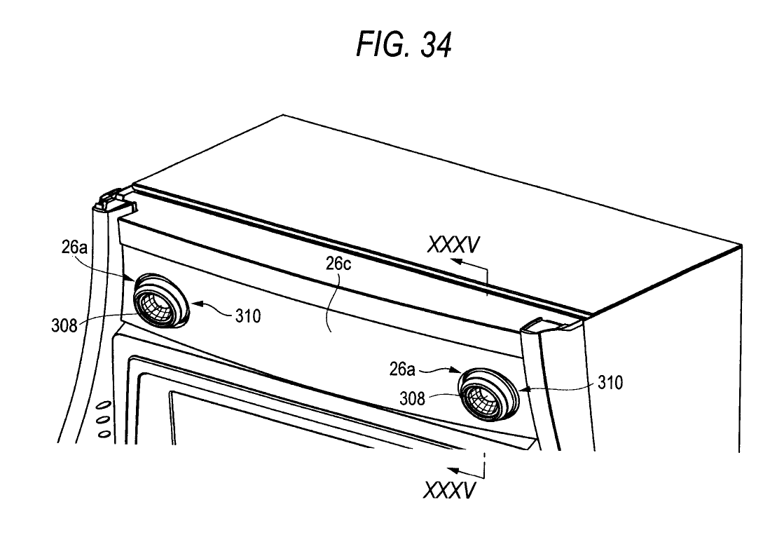

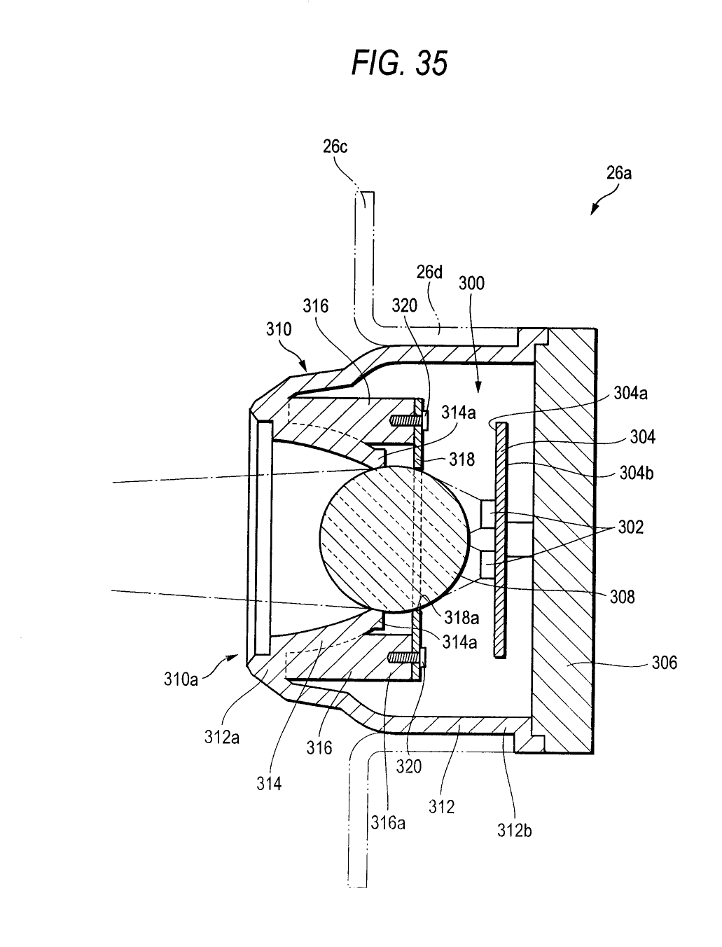

A detailed description will be given of the heretofore described power lamps 26a of the top lamp 26 while referring to FIGS. 34 and 35.

A cover plate 26c is disposed at a front of the top lamp 26, and the power lamps 26a are provided in such a way as to protrude from the cover plate 26c. The power lamps 26a, being lamps emitting light in the approximately horizontal direction, are each configured of a power lamp light emitting unit (a light emitting unit) 300 emitting the light, and a lens barrel (a light shielding portion ) 310 which causes the light from the power lamp light emitting unit 300 to emit from an opening 310a.

The power lamp light emitting unit 300 is configured of a substrate 304 provided with four LED's (light sources) 302, a support member 306 which supports the substrate 304, and a lens 308 through which light from the LED's 302 is transmitted. The substrate 304 being disposed approximately vertically in such a way as to face the opening 310a of the lens barrel 310, the four LED's 302 are provided on a front surface 304a thereof, aligned in two vertical and horizontal arrays. These LED's 302 being full color type LED's, a control of a lighting, a blinking or an emission color thereof is performed by a not-shown signal circuit.

The support member 306, supporting the substrate 304 from a rear surface 304b thereof, is fixed to a part of the heretofore described cabinet 3. A lens 308, being a spherical lens (a ball lens), is disposed to a front of and in proximity to the four LED's 302. For that reason, light emit from each LED 302 is transmitted through the lens 308, and heads toward the opening 310a of the lens barrel 310. The light emit from each lens 302 is refracted when transmitted through the lens 308, and emitted as converging light heading in the approximately horizontal direction.

The lens barrel 310, having an approximately cylindrical shape extending in the approximately horizontal direction, is fitted in a lamp installation portion 26d formed in a tubular shape in such a way as to warp rearward from the cover plate 26c. The lens barrel 310, surrounding the substrate 304 and the lens 308 in the power lamp light emitting unit 304 in an integrated manner, causes the light from the power lamp light emitting unit 300 to emit from the opening 310a, which is a front side opening.

The lens barrel 310 has an outer cylinder 312 on an outer side and an inner cylinder 314 positioned on an inner side of the outer cylinder 312. The outer cylinder 312, having an approximately cylindrical shape, decreases in diameter gently toward a front. A rear end portion 312b of the outer cylinder 312 is fixed to the heretofore described support member 306 of the power lamp light emitting unit 300. The inner cylinder 314, being provided in such a way as to enter an inside from a front end portion 312a of the outer cylinder 312, has a funnel shape decreasing in diameter toward a rear.

A pair of supporting posts 316 is formed, in upper and lower positions of the inner cylinder 314, between the outer cylinder 312 and the inner cylinder 314. Each support 316, also being a pole-like portion extending rearward from the front end portion 312a of the outer cylinder 312, passes between the outer cylinder 312 and the inner cylinder 314, and extends to a position posterior to a rear end portion 314a of the inner cylinder 314. A portion between the pair of supporting posts 316 being bridged by a plate 318 parallel to the heretofore described substrate 304 of the power lamp light emitting unit 300, the plate 318 is fixed by a screw 320 to an end surface of a rear end portion 316a of each support 316.

A circular hole 318a being formed in a center of the plate 318, the heretofore described lens 308 is fitted from a front side into the circular hole 318a. The lens 308, being in contact with the rear end portion 314a of the inner cylinder 314 positioned forward of the lens 308, is supported in such a way as to be sandwiched from a front and rear direction by the rear end portion 314a of the inner cylinder 314 and the plate 318.

In this kind of power lamp 26a, when the LED's 302 of the power lamp light emitting unit 300 emit light, the light, as well as being caused to fall incident on the lens 308 disposed forward of the LED's 302, is refracted in the lens 308, and becomes the converging light. That is, the light from the LED's 302, by being transmitted through the lens, is caused to converge, and becomes high linearity light heading in the approximately horizontal direction. Then, the light transmitted through the lens 308, by way of the inside of the inner cylinder 314, is caused to emit from the opening 310a of the lens barrel 310.

That is, in each power lamp 26a, as the LED's 302 and the lens 308 of the power lamp light emitting unit 300 are surrounded by the lens barrel 310, only the light, among the beams of light caused to emit from the LED's 302, which has been transmitted through the lens 308, is caused to emit from the opening 310a, and the other light is shielded by the lens barrel 310. Consequently, a radiation area of the light emit from the power lamp light emitting unit 300 of the power lamp 26a is limited to an area of the converging light (refer to dashed-dotted lines in FIG. 35) heading toward an approximately horizontal front from the lens 308.

For that reason, the player who, facing the display portion 4 and the operation buttons 11 (the operation unit) of the operation table 10 which are disposed at the front of the gaming machine 1, plays the game in a position immediately below the power lamps 26a, is out of the radiation area of the power lamps 26a, and the light from the power lamps 26a is not radiated on the player. Accordingly, the light from the power lamps 26a not being visible to the player, the reduction in the fatigue of the player is realized, and also, the player can concentrate on the game.

Also, as the light from the power lamps 26a is caused to converge in the approximately horizontal direction using the lens 308, in comparison with a case in which the light is dispersed, it is more difficult for the light emit from the power lamp light emitting unit 300 to head toward a lower side where the player is. That is, a situation, in which the light from the power lamp light emitting unit 300 is visible to the player, is more effectively avoided by means of the lens 308. In addition, it is easy for the light caused to converge by the lens 308 to reach far, increasing a degree of advertising of the light to a gallery far away. Moreover, as the power lamps 26a use the full color LED's 302 as the light sources of the power lamp light emitting unit 300, it being possible to realize various light effects which cannot be realized with monochromatic light sources, it is possible to improve a dramatic effect.

It not always being necessary that a light shielding portion such as the lens barrel is provided in such a way as to surround a periphery of the power lamp light emitting unit. It is sufficient to have an aspect in which the light shielding portion is interposed between the power lamp light emitting unit and the player in such a way as to be able to shield at least a part of light heading toward a player side. However, in a case in which the light shielding portion surrounds the periphery of the power lamp light emitting unit, as a situation of the light leaking from the light shielding portion can be avoided with a higher accuracy in comparison with a case in which the light shielding portion does not surround the periphery, it is preferable in that it is possible to more reliably avoid a situation in which the light from the power lamp light emitting unit is visible to the player.

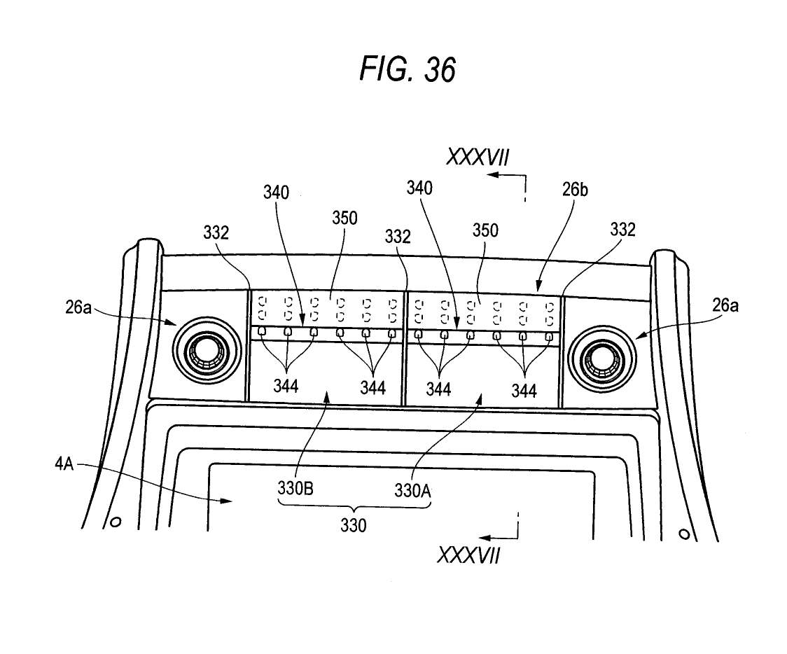

Next, a detailed description will be given, while referring to FIGS. 36 to 38, of the strip-shaped lamp 26b of the top lamp 26.

Between the heretofore described power lamps 26a disposed on both sides of the top lamp 26, a recessed portion 330 extending right and left over an approximately whole length between the power lamps 26a is provided on a rear side of the cover plate 26c. The recessed portion 330 being provided in such a way as to be recessed rearward with respect to the front surface of the cabinet 3 provided with the top lamp 26, the upper display portion 4A positioned below the top lamp 26 and the like, a cross-section thereof is approximately rectangular.

The recessed portion 330, being partitioned into two right and left portions by three walls 332 perpendicular to the cover plate 26c, is divided into a right recessed portion 330A and a left recessed portion 330B, each of which is sandwiched by a pair of the walls 332. A light source unit 340, which emits light, and a reflecting plate 350, which reflects the light from the light source unit 340, are housed inside each of the right recessed portion 330A and the left recessed portion 330B. The strip-shaped lamp (the light emitting unit) 26b is configured of the recessed portion 330, the light source unit 340 and the reflecting plate 350.

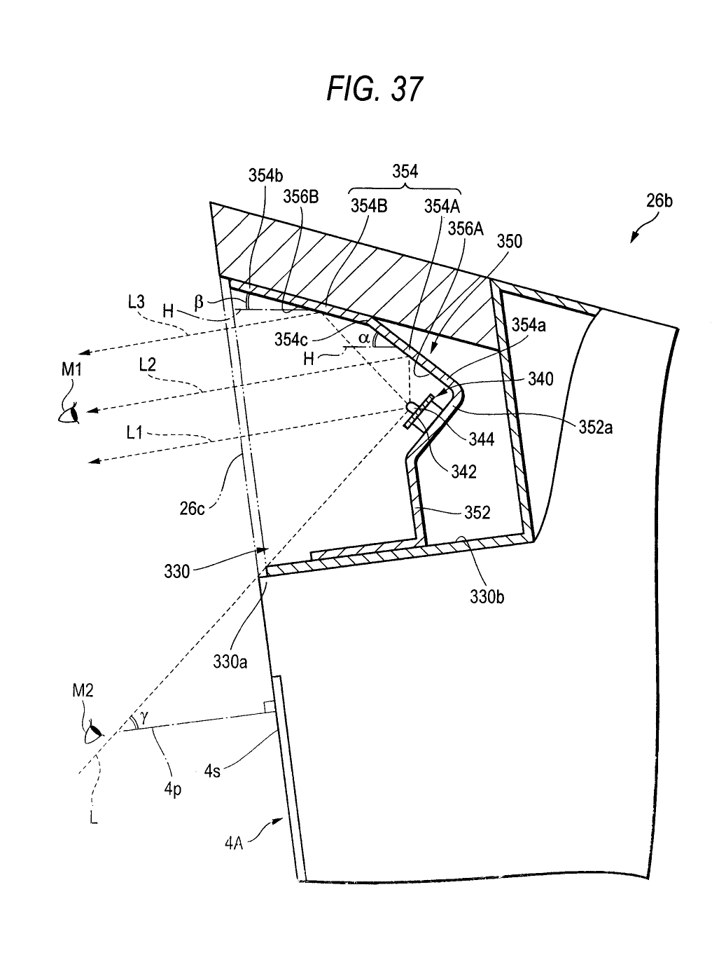

The light source unit 340, being disposed in such a way as to extend in the right and left direction in a height position approximately halfway between the recessed portions 330A and 330B, is configured of a reed-shaped substrate 342 and six LED's (light sources) 344 installed at equal intervals on a substrate surface in an extending direction of the substrate 342. The substrate 342 extends horizontally, and is inclined in such a way that the surface thereof faces diagonally upward. Each LED 344 provided on the substrate 342 being, for example, a white LED, a control of lighting or blinking is performed by a not-shown signal circuit. Supposing that a straight line connecting the LED 344 and a lower edge 330a of the recessed portion 330 is designated as a straight line L (refer to FIG. 37), the LED 344 is in a position in which the straight line L intersects with a perpendicular line from the front surface of the cabinet 3 (for example, a perpendicular line 4p from a display surface 4s of the upper display portion 4A) at an acute angle γ.

The reflecting plate 350, being a member made by bending forming a stainless plate material, is configured of a support 352, which supports the light source unit 340 from below, and a reflecting portion 354 positioned on an upper side of the support 352. The support 352, being provided in such a way as to stand up from a bottom surface 330b of the recessed portion 330, supports the substrate 342 of the light source unit 340 from a rear surface side thereof. The reflecting portion 354 extends diagonally upward and forward from an upper end portion 352a of the support 352 positioned on a rear side of the light source unit 340. The reflecting portion 354, bending downward at a bending portion 354c in a vicinity of a center between a lower end portion 354a and an upper end portion 354b thereof, is divided into a first reflecting portion 354A below the bending portion 354c and a second reflecting portion 354B above the bending portion 354c.

Herein, front surfaces of the first reflecting portion 354A and the second reflecting portion 354B being made reflective and forming reflecting faces 356A and 356B respectively, the reflecting face 356A of the first reflecting portion 354A is inclined at an inclined angle (a first inclined angle) α with respect to a horizontal plane H, while the reflecting face 356B of the second reflecting portion 354B is inclined at an inclined angle (a second inclined angle) β with respect to the horizontal plane H. As described heretofore, as the reflecting portion 354 bends downward at the bending portion 354c, the inclined angle β of the reflecting face 356B of the second reflecting portion 354B is smaller than the inclined angle α of the reflecting face 356A of the first reflecting portion 354A.

A part of the light from the LED's 344 of each light source unit 340 is reflected off the reflecting faces 356A and 356B of the reflecting portion 354, and heads toward an opening of the recessed portion 330 which is an opening of the strip-shaped lamp 26b. At this time, as the second reflecting portion 354B is positioned on a side farther away from the LED's 344 than the first reflecting portion 354A, and the inclined angle β of the reflecting face 356B of the second reflecting portion 354B is smaller than the inclined angle α (of the reflecting face 356A of the first reflecting portion 354A, light reflected off the reflecting face 356A of the first reflecting portion 354A, and light reflected off the reflecting face 356B of the second reflecting portion 354B, shift up or down, and travel in approximately the same direction.

Next, a description will be given of a visibility of the light in the strip-shaped lamp 26b.

As the gallery in a standing position faces the gaming machine 1, a height of an eye line of a gallery M1 being on the same order as a height of the strip-shaped lamp 26b, the light caused to emit in the horizontal direction from the strip-shaped lamp 26b reaches the gallery. That is, as shown by an arrow L1 of FIG. 37, the light from the LED's 344 of the light source unit 340 directly reaches the gallery M1 via the cover plate 26c fitted in the opening of the strip-shaped lamp 26b (that is, the opening of the recessed portion 330). Also, apart from the direct light L1 from the LED's 344, as shown by arrows L2 and L3 of FIG. 37, lights L2 and L3 from the LED's 344, reflected off the reflecting portion 354, reach the gallery M1 via the cover plate 26c. As the reflecting portion 354 has the first reflecting portion 354A and the second reflecting portion 354B, the lights L2 and L3 reflected off them reach the gallery M1 in two upper and lower tiers, the upper reflected light L3 and the lower reflected light L2.

Consequently, as shown in FIG. 36, three-tiered light of the light L1 emitted from the LED 344 and the lights L2 and L3 reflected off the reflecting portion 354 is visible to the gallery. For that reason, in the strip-shaped lamp 26b, three-tiered light from the right recessed portion 330A and three-tiered light from the left recessed portion 330B are visible from the eye line of the gallery. As the partition wall 332 between the right recessed portion 330A and the left recessed portion 330B is thin, it appearing to the gallery that the light from the right recessed portion 330A and the light from the left recessed portion 330A are continuous, strip-shaped light divided into three vertical tiers is visually perceived as a whole of the strip-shaped lamp 26b.

Meanwhile, as the player in a sitting position faces the gaming machine 1, a height of an eye line of a player M2 is several tens of centimeters below the strip-shaped lamp 26b, and is slightly above the straight line L connecting the LED's 344 and the lower edge 330a of the recessed portion 330. For that reason, the player M2 can visually perceive the light emitted from the LED's 344, but cannot visually perceive the light reflected off the reflecting portion 354. This is because the light reflected off the first reflecting portion 354A becomes invisible by approximately overlapping the light emitted from the LED's 344, and because the light reflected off the second reflecting portion 354B is not reflected in a direction of the view point of the player.

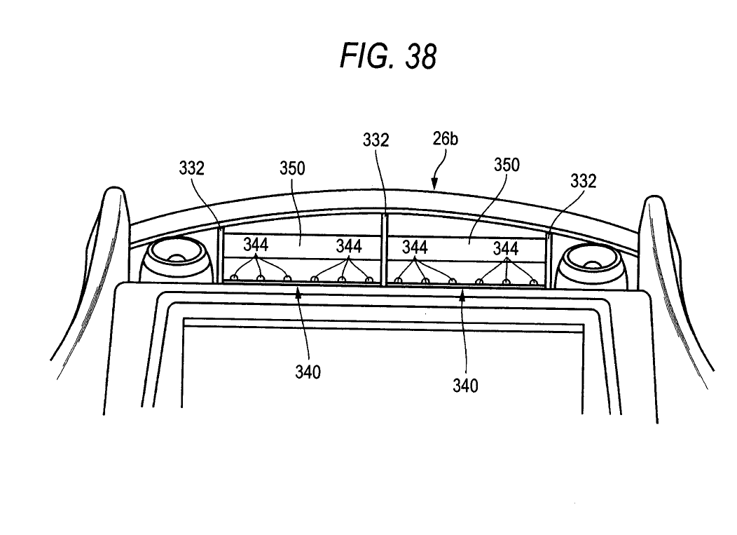

Consequently, as shown in FIG. 38, single tier of the light emitted from the LED's 344 is visible to the player. For that reason, in the strip-shaped lamp 26b, the single tier of light from the right recessed portion 330A and the single tier of light from the left recessed portion 330B being visible from the eye line of the player, a single strip-shaped beam of light is visible as the whole of the strip-shaped lamp 26b.

As described heretofore, in the strip-shaped lamp 26b of the gaming machine 1, three strip-shaped beams of light are visible to the gallery, while only one strip-shaped beam of light is visible to the player. For this reason, in the strip-shaped lamp 26b, a quantity of light heading toward the player is smaller than a quantity of light heading toward the gallery. That is, a quantity of light visible to the player from the strip-shaped lamp 26b is reduced, by which means the fatigue of the player who continues the game is reduced.

As the reflecting portion 354 has the first reflecting portion 354A and the second reflecting portion 354B, the reflected light from the LED's 344 is heading toward the gallery through two paths L2 and L3. For that reason, in comparison with a case in which the reflected light from the LED's 344 heads toward the gallery through one path, the quantity of light from the strip-shaped lamp 26b is increased, and a light emitting area is widened, improving a degree of attraction by the strip-shaped lamp 26b. By an apparent number of light sources being increased by a mirror image of the LED's 344 due to the reflecting portion 354, it is possible to reduce a number of LED's 344 actually used to ⅓, realizing a reduction in a number of parts and an energy saving.

In the strip-shaped lamp 26b, as the LED's 344 of the light source unit 340 are disposed in such a way that the straight line L connecting each LED 344 and the lower edge 330a of the recessed portion 330 intersects with the perpendicular line from the front surface of the cabinet 3 at the acute angle γ, a majority of the light from the LED's 344 heading toward the player is shielded by the lower edge 330a of the recessed portion 330, effectively reducing the quantity of light heading toward the player.

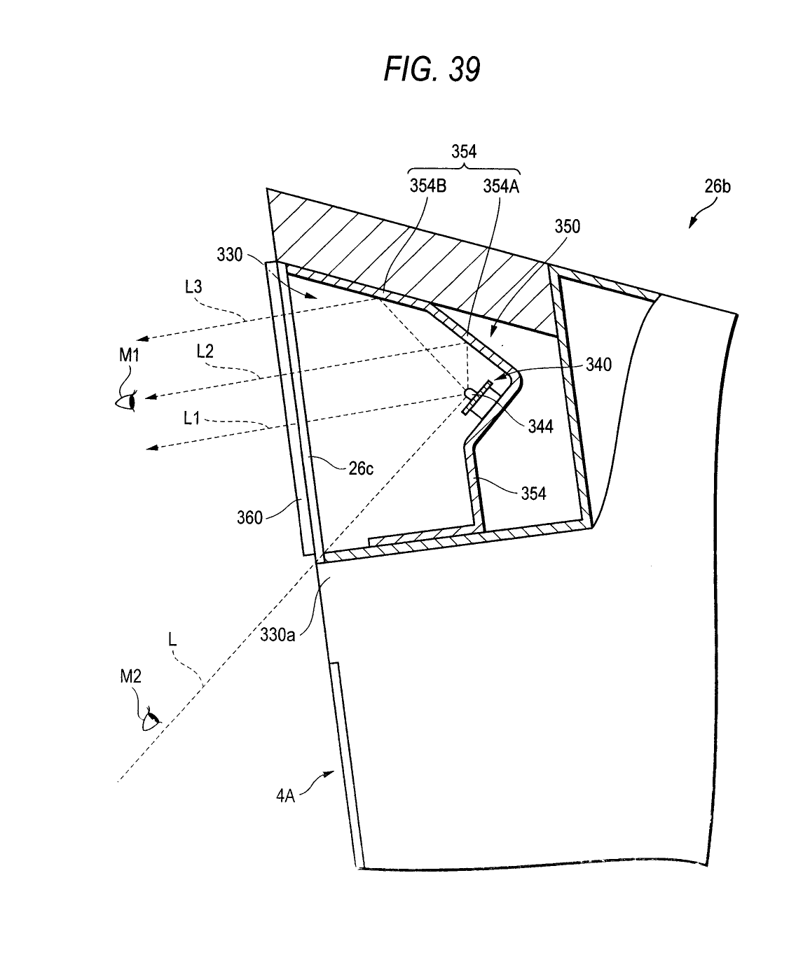

In order to adjust the quantity of light from the strip-shaped lamp 26b, as shown in FIG. 39, it is acceptable that a polarizing filter 360 is attached to a surface of the cover plate 26c. The polarizing filter 360, being attached in such a way as to cover a whole of the cover plate 26c, transmits light falling incident at a nearly vertical angle, and shields light falling incident at a predetermined incidence angle or greater. For this reason, a gallery, whose eye line has approximately the same height as a height of the polarizing filter 360, can visually perceive the light emit from the strip-shaped lamp 26b to the same degree as in a case in which there is no polarizing filter 360.

Meanwhile, the light emit from the strip-shaped lamp 26b being shielded by the polarizing filter 360, a player who looks up at the polarizing filter 360 from below can hardly visually perceive the light from the strip-shaped lamp 26b. Consequently, by adopting this kind of polarizing filter 360, a quantity of light visible to the player from the strip-shaped lamp 26b is more effectively reduced, realizing a further reduction in the fatigue of the player.

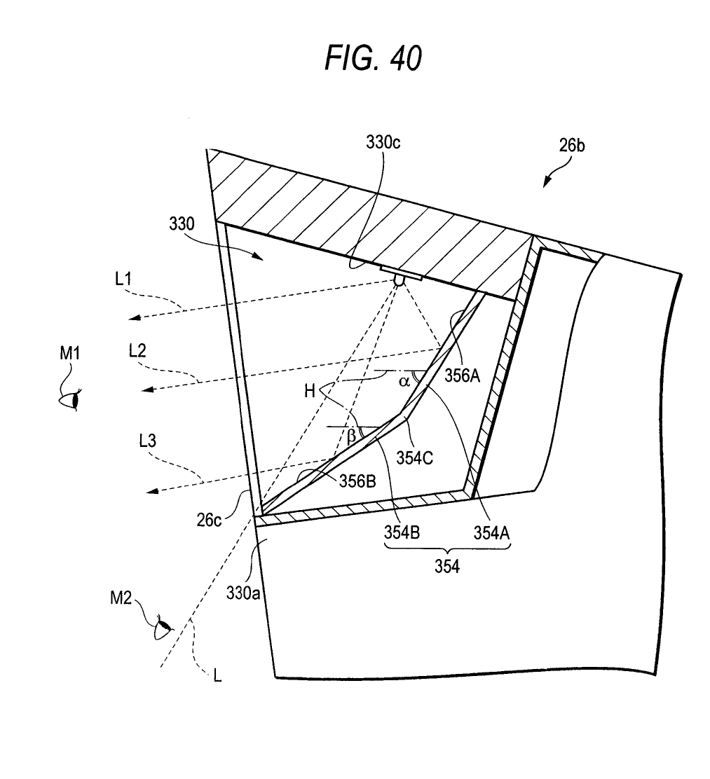

As shown in FIG. 40, it is also acceptable that the heretofore described strip-shaped lamp 26b has an aspect in which a positional relationship between the light source unit 340 and the reflecting plate 350 is reversed. That is, in the strip-shaped lamp 26b shown in FIG. 40, the light source unit 340 being installed on a ceiling plane 330c of the recessed portion 330, the reflecting portion 354 is disposed below the light source unit 340.

In the reflecting portion 354, a portion thereof above the bending portion 354c forms the first reflecting portion 354A having the reflecting face 356A of the inclined angle α, and a portion below the bending portion 354c forms the second reflecting portion 354B having the reflecting face 356B of the inclined angle β. That is, in the same way as the heretofore described embodiment, the second reflecting portion 354B is positioned on a side farther away from the LED's 344 than the first reflecting portion 354A, and the inclined angle β of the reflecting face 356B of the second reflecting portion 354B is smaller than the inclined angle α of the reflecting face 356A of the first reflecting portion 354A.

In the heretofore described strip-shaped lamp 26b, in the same way as in the heretofore described embodiment, the light emitted from the LED's 344 and the three-tiered beams L1, L2 and L3 of the light reflected off the reflecting portion 354 are visible to the gallery M1, and only the light emitted from the LED's 344 is visible to the player M2. This is because the light reflected off the reflecting portion 354 is not reflected in the direction of the view point of the player M2 which is slightly above the straight line L connecting each LED 344 and the lower edge 330a of the recessed portion 330.

That is, in the strip-shaped lamp 26b of the aspect shown in FIG. 40, in the same way as the strip-shaped lamp 26b shown in FIG. 37, three strip-shaped beams of light are visible to the gallery, while only one strip-shaped beam of light is visible to the player, and the quantity of light heading toward the player is smaller than the quantity of light heading toward the gallery. For that reason, the quantity of light visible to the player from the strip-shaped lamp 26b is reduced, realizing the reduction in the fatigue of the player who continues the game.

Hereafter, a detailed description will be given, while referring to the drawings, of another embodiment of the invention.

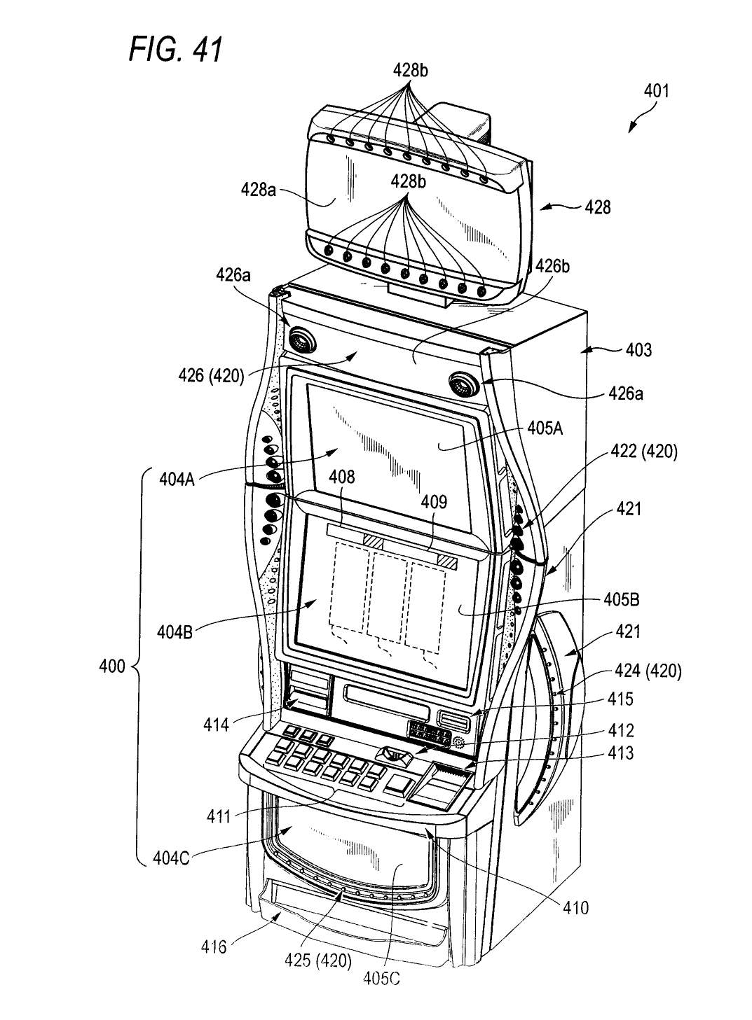

As shown in FIG. 41, a gaming machine 401, being an upright-type slot machine to be installed in a game arcade or a casino, has a cabinet 403 for housing electrical or mechanical parts for executing a predetermined gaming state. A display portion 404 for displaying information relating to a game including, for example, an upper display portion 404A, a middle display portion 404B and a lower display portion 404C, the display portions 404A to 404C are attached to a front surface of the vertically long cabinet 403. The upper display portion 404A, having a liquid crystal panel 405A disposed above the display portion 404B, displays, for example, an effect image, an introduction of game details, an explanation of game rules and the like by means of the liquid crystal panel 405A. The lower display portion 404C, being disposed below the display portion 404B, has a plastic panel 405C on which an image is printed, and lights up the plastic panel 405C by means of a backlight.

The display portion 404B for displaying a gaming state of the game having the transparent liquid crystal panel 405B fixed to a front door of the cabinet 403, it is possible for a player to see symbols of three reels R1, R2 and R3, disposed inside the cabinet 403, from outside via the liquid crystal panel 405B. A plurality of pay lines arranged to traverse the display portion 404B horizontally and diagonally are printed in areas of the display portion 404B corresponding to the three reels R1, R2 and R3. A payout amount display portion 408 and a credit amount display portion 409 are displayed in an upper portion of the display portion 404B. The middle display portion 404B, being inclined in such a way that the upper portion tilts rearward, is configured in such a way that the player can play in a comfortable position.

An operation table 410 protruding forward being provided at a front of the cabinet 403, between the middle display portion 404B and the lower display portion 404C, as an operation unit which instructs an execution of the game, various kinds of operation button 411, such as a BET button, a COLLECT button, a START button, a STOP button and the like, are arranged on the operation table 410. A coin slot 412 and a bill slot 413 are provided on the operation table 410. A ticket printer 414 and a card reader 415 are provided between the operation table 410 and the middle display portion 404B. Furthermore, a coin tray 416 is provided in a lowermost portion of the cabinet 403.

A light emitting unit 420 is disposed on the cabinet 403 of the gaming machine 401 in such a way as to surround a game area including the upper display portion 404A, the middle display portion 404B, the lower display portion 404C and the operation table 410. The light emitting unit 420 is configured of side lamps 422, which are provided on oblique light bases 421 protruding bow-like laterally from right and left end portions of the cabinet 403 across the upper display portion 404A and the display portion 404B, speaker lamps 424, which are provided on edges of bow shaped speakers 423 protruding laterally from right and left end portions of the cabinet 403 in positions near the operation table, under lamps 425, which are provided on a lower edge of the lower display portion 404C, and a top lamp 426 which, being provided above the upper display portion 404A, has power lamps 426a disposed on both sides and a strip-shaped lamp 426b arranged in a center in a horizontal direction. The light emitting unit 420 creates an attractive illumination by a lamp control.

In the heretofore described gaming machine 401, by supplementing light from the display portion 404 and the operation buttons 411 on the operation table 410 with light from the light emitting unit 420 disposed in such a way as to surround the game area, in cooperation with the light from the display portion 404 in the game area and the light from the operation buttons 411 on the operation table 410, it is possible, using the light, to markedly improve a degree of advertising of the gaming machine 401 to a gallery. By appropriately changing a lighting condition or a blinking condition of the light emitting unit 420, it is possible, using the light, to easily distinguish the gaming machine 401 from another machine. Accordingly, it is possible to provide an attractive gaming machine.

The gaming machine 401 further includes a topper effect producing device 428 (which serves as an effect producing device) mounted on the cabinet 403. The topper effect producing device 428, having a rectangular thin-boxed shape, is disposed in such a way as to be approximately parallel to the liquid crystal panel 405A of the upper display portion 404A.

A plastic panel 428a, on which an image is printed, being fitted in a front surface of the topper effect producing device 428, a configuration is such that the plastic panel 428a is lit up by a built-in backlight 498 (not shown in FIG. 41). Also, on the front surface of the topper effect producing device 428, a plurality of LED's 428b are disposed at equal intervals along upper and lower sides of the plastic panel 428a.

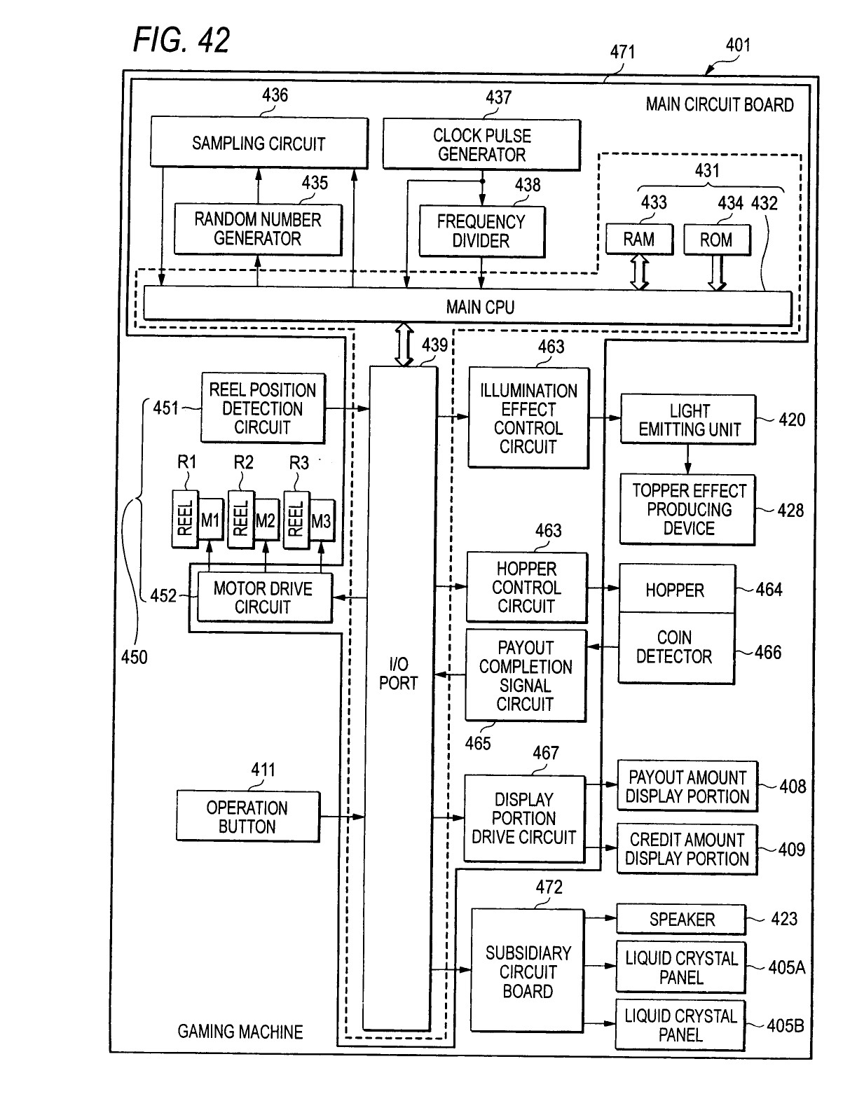

Next, a description will be given, while referring to FIGS. 42 to 45, of an internal configuration of the heretofore described gaming machine 401.

FIG. 42 is a block diagram showing an internal configuration of a whole of the gaming machine 401. As shown in FIG. 42, the gaming machine 401 has a plurality of components centered around a main circuit board 471 on which a microcomputer 431 is mounted. The main circuit board 471, having the microcomputer 431, a random number generator 435, a sampling circuit 436, a clock pulse generator 437 and a frequency divider 438, has an illumination effect control circuit (illumination controller) 461, a hopper control circuit 463, a payout completion signal circuit 465 and a display portion drive circuit 467.

The microcomputer 431 has a main CPU 432, an RAM 433 and an ROM 434. The main CPU 432, operating in accordance with a program stored in the ROM 434, by performing a reception and a transmission of a signal from and to another component via an I/O port 439, performs an operation control of the whole of the gaming machine 401. Data and programs used when the main CPU 432 operates are stored in the RAM 433 and, for example, as well as a random number sampled by the sampling circuit 436, to be described hereafter, being temporarily held after a start of the game, code numbers of the reels R1, R2 and R3 and symbol numbers are stored therein. A program, which the main CPU 432 executes, and permanent data are stored in the ROM 434.

The random number generator 435, operating in accordance with an instruction from the main CPU 432, generates random numbers in a certain range. The sampling circuit 436, in accordance with an instruction from the main CPU 432, as well as extracting an optional random number from among random numbers generated by the random number generator 435, inputs the extracted random number into the main CPU 432. The clock pulse generator 437 generates a standard clock pulse for operating the main CPU 432, and the frequency divider 438 inputs a signal, in which the standard clock pulse is divided by a certain frequency, into the main CPU 432.

Also, a reel drive unit 450 is connected to the main circuit board 471. The reel drive unit 450 has a reel position detection circuit 451, which detects a position of each reel R1, R2 and R3, and a motor drive circuit 452 which inputs a drive signal into motors M1, M2 and M3 for rotating the reels R1, R2 and R3 respectively. By the drive signal being input from the motor drive circuit 452, the motors M1, M2 and M3 are operated to rotate the reels R1, R2 and R3 respectively.

Furthermore, the operation buttons 411, including the STOP button for inputting an instruction to stop the reel R1, R2 or R3, the START button, the COLLECT button, the BET button and the like, being connected to the main circuit board 471, a signal corresponding to a button recessed portion is input into the main CPU 432 via the I/O portion 439.

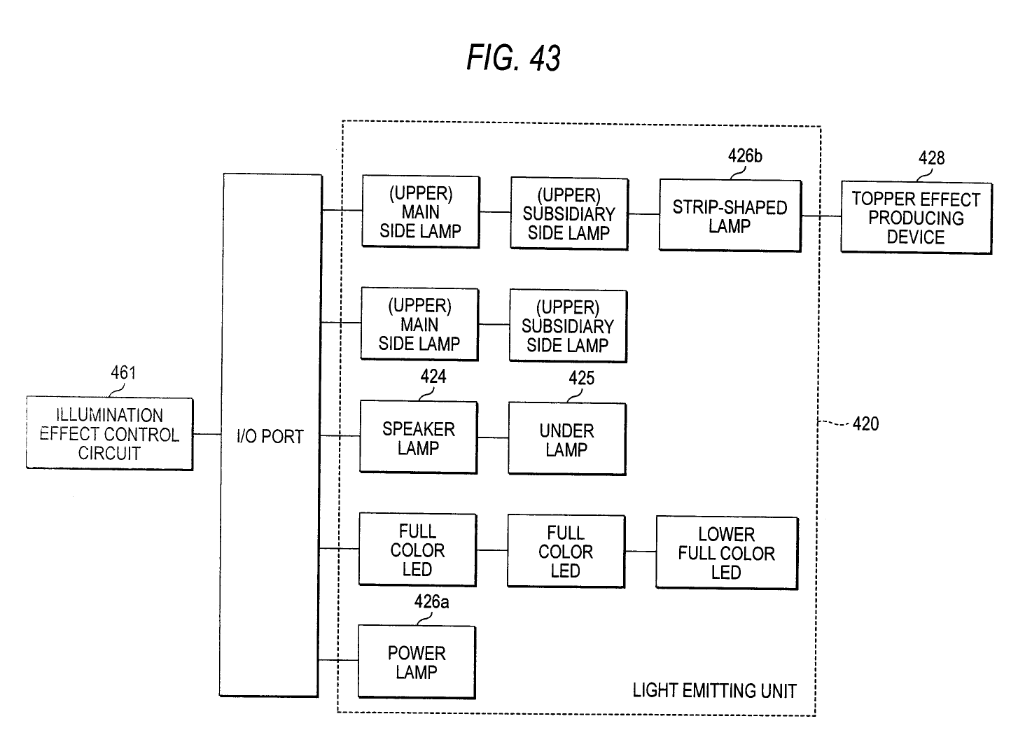

The illumination effect control circuit 461 transmits an effect signal for causing the heretofore described light emitting unit 420 and topper effect producing device 428 to perform an illumination effect. The light emitting unit 420, as shown in FIG. 43, is configured of a plurality of lamps including the heretofore described speaker lamps 424, under lamps 425, power lamps 426a and strip-shaped lamp 426b, and LED's. Main side lamps and subsidiary side lamps shown in FIG. 43 configure the heretofore described side lamps 422 provided on the oblique light bases 421. A plurality of full color LED's shown in FIG. 43 are attached to the liquid crystal panel 405B to decorate both right and left sides of the liquid crystal panel 405B. The lower full color LED's light up the coin tray 416. The topper effect producing device 428 is serially connected to the illumination effect control circuit 461 via the light emitting unit 420 of this kind of configuration.

The hopper control circuit 463 drives the hopper 464 in accordance with a control of the main CPU 432, the hopper 464, and performs an operation for performing a payout of a coin into the coin tray 416. The payout completion signal circuit 465 receives data of a coin quantity value from a coin detector 466 connected thereto and, in the event that the quantity value reaches data of a set quantity value, inputs a signal informing of a coin payout completion into the main CPU 432. The coin detector 466 counts an amount of coins paid out by the hopper 464, and inputs data of the counted quantity value into the payout completion signal circuit 465. The display portion drive circuit 467 controls a display operation of each kind of display portion such as the payout amount display portion 408 and the credit amount display portion 409.

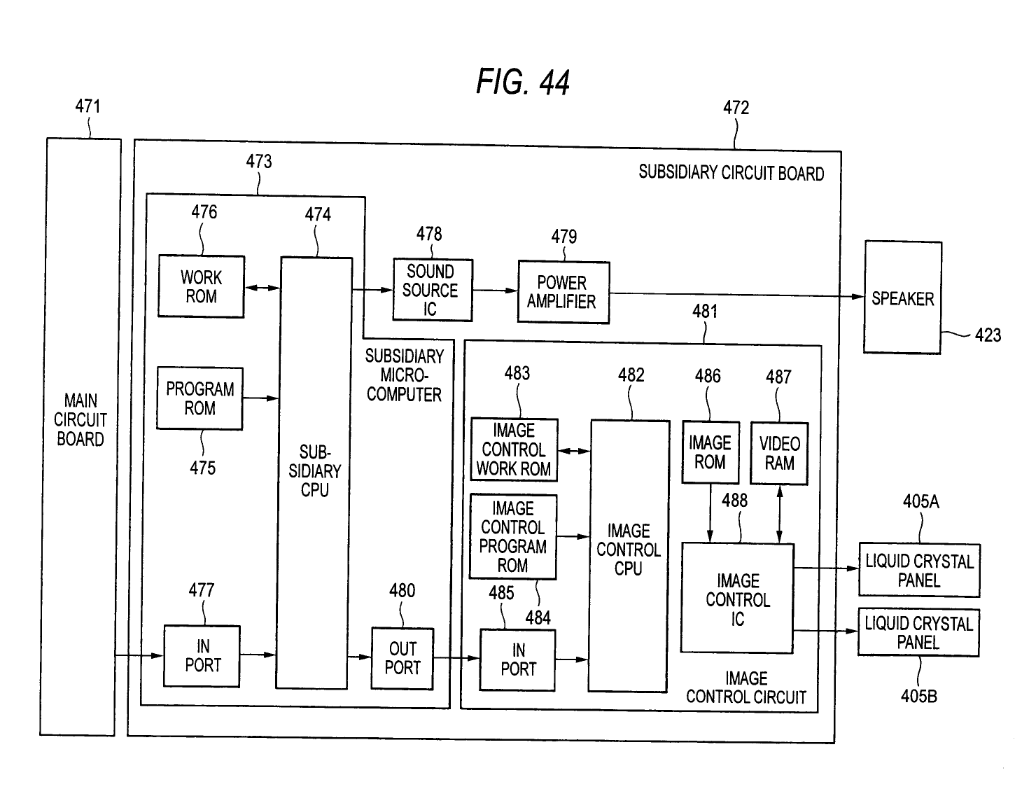

A subsidiary circuit board 472 is connected to the main circuit board 471. The subsidiary circuit board 472, as shown in FIG. 44, receives a command from the main circuit board 471, and performs a display control of the liquid crystal panel 405A of the upper display portion 404A and the liquid crystal panel 405B of the display portion 404B, and an emission control of a sound from the speakers 423. The subsidiary circuit board 472 is configured on a circuit substrate separate from the circuit substrate configuring the main circuit board 471, with a microcomputer (hereafter called a “subsidiary microcomputer”) 473 as a main component, and has a sound source IC 478 that controls the sound emitted from the speakers 423, a power amplifier 479 that amplifies an output from the sound source IC 478, and an image control circuit 481 that operates as a display controller of the liquid crystal panels 405A and 405B.

The subsidiary microcomputer 473 is provided with a subsidiary CPU 474 that performs a control operation in accordance with a control command transmitted from the main circuit board 471, a program ROM 475 that serves as a storage unit, a work RAM 476, and I/O ports 477 and 480. The subsidiary circuit board 472, although not including the clock pulse generator, the frequency divider, the random number generator or the sampling circuit, is configured in such a way as to execute a random number sampling on an operation program of the subsidiary CPU 474. The program ROM 475 stores a control program executed by the subsidiary CPU 474. The work RAM 476 is configured as temporary storage unit for when the control program is executed by the subsidiary CPU 474.

The image control circuit 481 is provided with an image control CPU 482, an image control work RAM 483, an image control program ROM 484, an image ROM 486, a video RAM 487 and an image control IC 488. The image control CPU 482, based on parameters set by the subsidiary microcomputer 473, determines an image to be displayed on the liquid crystal panels 405A and 405B, in accordance with an image control program stored in the image control program ROM 484.

The image control program relating to the display on the liquid crystal panels 405A and 405B, and various kinds of selection table, are stored in the image control program ROM 484. The image control work RAM 483 is configured as temporary storage unit for when the image control program is executed by the image control CPU 482. The image control IC 488 forms an image corresponding to details determined by the image control CPU 482, and transmits it to the liquid crystal panels 405A and 405B.

The image ROM 486 stores dot data (bitmap data) for forming an image. The video RAM 487 operates as temporary storage unit for when the image is formed by the image control IC 488.

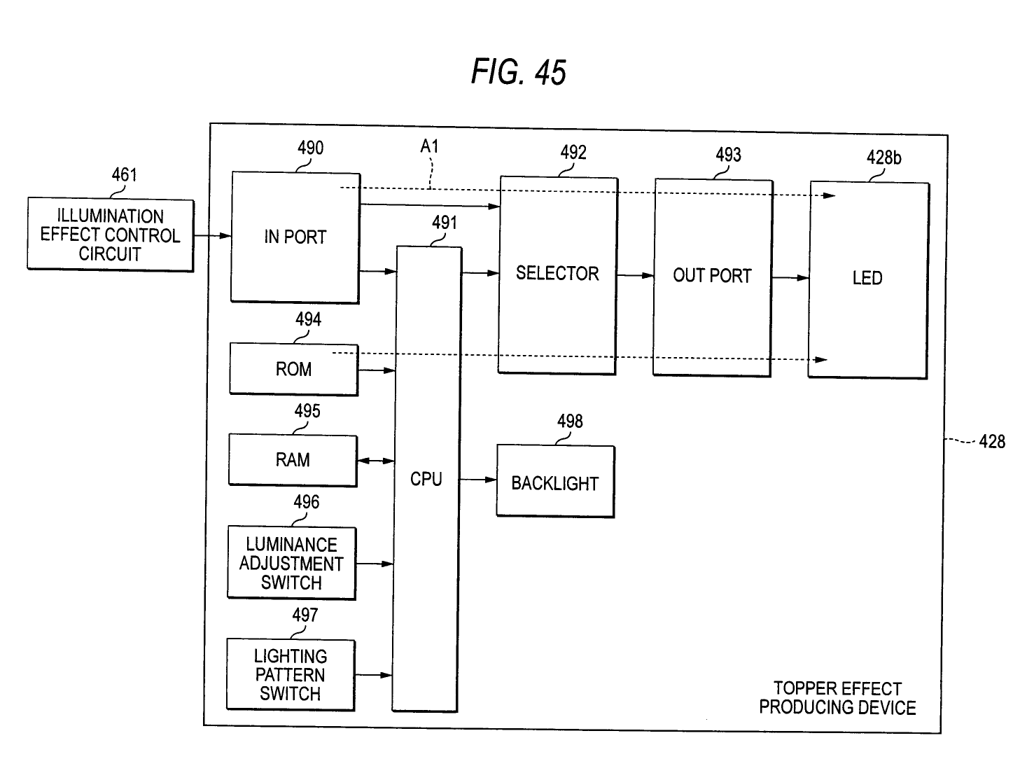

FIG. 45 is a block diagram showing an internal configuration of the topper effect producing device 428 of the gaming machine 401. As shown in FIG. 45, the topper effect producing device 428 has an IN port 490, which receives information from the illumination effect control circuit 461 outside the device, a CPU 491, which performs various kind of calculation process, a selector 492, which performs a selection transmission of an effect signal, and an OUT port 493 which sends the effect signal to the LED's 428b.

The IN port 490 of the topper effect producing device 428 is serially connected to the illumination effect control circuit 461 of the main circuit board 471 via the light emitting unit 420. The IN port 490, being effect information reception means, receives effect information (hereafter called first effect information) relating to the illumination effect of the topper effect producing device 428 from the illumination effect control circuit 461. Effect detail information instructing effect details such as a lighting pattern of each LED 428b is included in the first effect information. For that reason, in a case in which the first effect information is transmitted from the OUT port 493 as the effect signal, the LED's 428 serving as effect means perform an illumination effect corresponding to the effect detail information included in the first effect information. The first effect information received by the IN port 490 is transmitted in parallel to the CPU 491 and the selector 492.

An ROM 494 and an RAM 495, which are effect information storage unit, being connected to the CPU 491, effect information (hereafter called second effect information) relating to the illumination effect of the topper effect producing device 428 is stored in the ROM 494. Although, in the same way as in the first effect information, effect detail information instructing effect details such as the lighting pattern of each LED 428b is also included in the second effect information, the relevant effect detail information differs from the effect detail information included in the first effect information.

The CPU 491, when a predetermined effect condition is satisfied, as well as transmitting an effect signal corresponding to the effect detail information included in the second effect information, which is stored in the ROM 494, to the selector 492, sends to the selector 492 a switching command instructing the selector 492 to transmit the effect signal in place of the first effect information. Herein, the effect condition in the embodiment is that there is no inputting of the first effect information from the IN port 490 into the CPU 491. That is, when there is no input of the first effect information from the IN port 490 into the CPU 491, the CPU 491, as well as transmitting an effect signal corresponding to the second effect information to the selector 492, sends the switching command to the selector 492. It is also acceptable that the effect condition, not being limited to the heretofore described condition, is an elapsing of a predetermined time period, a coming of a predetermined time, a reception of a specified signal from the illumination effect control circuit 461 or the like.

The selector 492, based on the switching command sent from the CPU 491, transmits either the effect signal corresponding to the first effect information sent from the IN port 490, or the effect signal corresponding to the second effect information sent from the CPU 491, to the LED's 428b via the OUT port 493. That is, effect signal transmission means, being configured of the heretofore described CPU 491, selector 492 and OUT port 493, based on the predetermined effect condition, transmits either an effect signal based on the first effect information received by the IN port 490, or an effect signal based on the second effect information stored in the ROM 494, to the LED's 428b.

A luminance adjustment switch 496, a lighting pattern switch 497 and a backlight 498 are connected to the CPU 491. The luminance adjustment switch 496, being a DIP switch for controlling a time interval between an ON and an OFF of each LED 428b and adjusting a luminance, sends a signal for causing the CPU 491 to perform a multistage luminance adjustment (for example, four-stage adjustment) to the CPU 491. The lighting pattern switch 497, being a switch used for setting the lighting pattern of each LED 428b as an effect change condition, inputs a signal for causing the CPU 491 to set various kinds of lighting pattern, to be described hereafter, into the CPU 491. By the CPU 491 causing only an LED 428b in a predetermined place, among the plurality of LED's 428b, to light and/or flash, a confirmation is performed as to which lighting pattern has been set. The backlight 498 is an illumination unit that illuminates the plastic panel 428a of the topper effect producing device 428 in response to a transmission signal from the CPU 491. A cold-cathode tube may be used as the backlight 498.

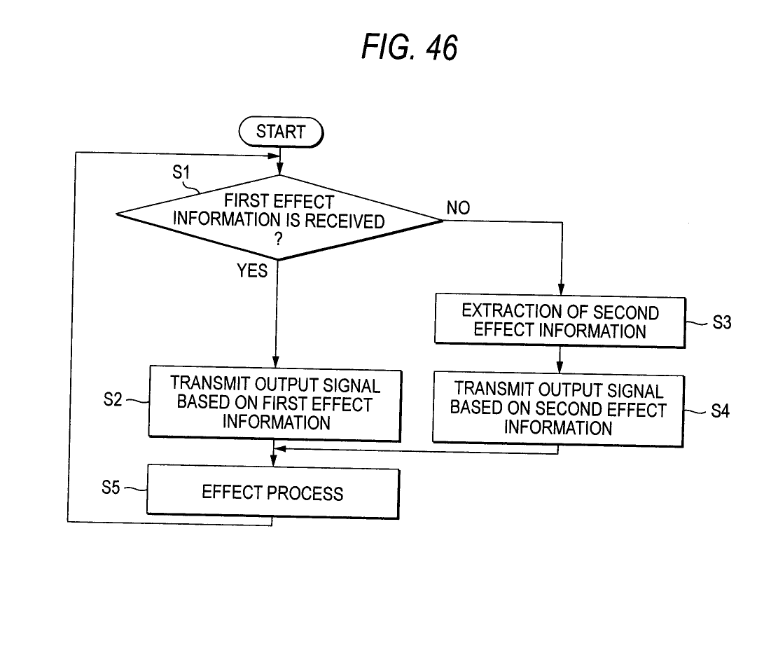

Next, a description will be given, while referring to FIG. 46, of a procedure of an effect process in the topper effect producing device 428.

The CPU 491, by receiving the first effect information sent from the IN port 490, constantly or intermittently monitoring whether or not the IN port 490 has received the first effect information, performs a determination of the effect condition (Step 1). Then, if the CPU 491 has detected the reception of the first effect information from the IN port 490, it sends the switching command for transmitting the effect signal corresponding to the first effect information to the selector 492, and the effect signal is transmitted from the selector 492 via the OUT port 493 to the LED's 428b (Step 2).

Meanwhile, the CPU 491 performs the determination of the effect condition (Step 1) and, if it has not detected the reception of the first effect information from the IN port 490, it extracts the second effect information from the ROM 494 (Step 3). Then, the CPU 491 sends the switching command for transmitting the effect signal of the second effect information to the selector 492, along with the effect signal corresponding to the second effect information, to the selector 492. Continuing on, the effect signal sent to the selector 492 from the CPU 491 is transmitted to the LED's 428b, via the OUT port 493, from the selector 492 (Step 4).

Then, the LED's 428b perform an effect corresponding to the effect signal sent from the OUT port 493 (Step 5). In the topper effect producing device 428, the above steps 1 to 5 are repeated as the effect process. Consequently, when the first effect information has been input from the illumination effect control circuit 461 into the topper effect producing device 428, as shown by an arrow Al, the LED's 428b perform an illumination effect corresponding to the first effect information. Meanwhile, when the first effect information has not been input from the illumination effect control circuit 461 into the topper effect producing device 428, as shown by an arrow A2, the LED's 428b perform an illumination effect corresponding to the second effect information stored in the ROM 494 of the topper effect producing device 428.

That is, in the topper effect producing device 428, as the LED's 428b perform not only the illumination effect corresponding to the first effect information received from an exterior, but also an effect corresponding to the effect signal of the second effect information stored in the ROM 494, a diversification of effects being achieved, it is possible to perform an effect richer in variety. Moreover, even in the event that the inputting of the first effect information from the illumination effect control circuit 461 into the topper effect producing device 428 has been interrupted because of a disconnection of a line or the like, as the effect based on the second effect information is performed, it is possible to continuously perform the effect due to the topper effect producing device 428.

Also, in the heretofore described embodiment, as the effect detail information relating to the effect details of the LED's 428b is included in the first effect information, it is not necessary for the topper effect producing device 428 to store the effect detail information. That is, in the topper effect producing device 428, it not being necessary to newly provide storage unit for the effect detail information, or allot a part of a storage area of the ROM 494 in which the second effect information is stored, an efficient use is made of the storage area of the topper effect producing device 428.

However, it is also possible, as necessary, to have an aspect in which at least a part of the effect detail information relating to the effect details of the LED's 428b is stored in the ROM 494 and, when the first effect information is input into the IN port 490, the CPU 491 extracts the effect detail information, and sends it to the LED's 428b. For example, it is also possible to have an aspect in which effect detail information relating to the lighting pattern of each LED 428b is stored in the ROM 494 and, when the first effect information including only a light emitting timing as the effect detail information is input into the IN port 490, the CPU 491 extracts the effect detail information relating to the lighting pattern, and sends it to the LED's 428b.

Furthermore, in the heretofore described embodiment, the topper effect producing device 428 is serially connected to the illumination effect control circuit 461 of the main circuit board 471 via the light emitting unit 420. By adopting this kind of serial connection, it is possible to add on the light emitting unit or the effect device, and also, wirings necessary for the connection are reduced in number.

Although the heretofore described embodiment shows an aspect in which one item of second effect information is stored in the ROM 494, it is also acceptable to appropriately change to an aspect in which a plurality of items of second effect information including different items of effect detail information are stored in the ROM 494. In this case, the CPU 491, in Step 3 in the effect process of the topper effect producing device 428, selects and extracts one of the plurality of items of second effect information and, in Step 4, transmits the selected second effect information to the LED's 428b (refer to FIG. 46). In this way, by storing the plurality of items of second effect information in the ROM 494, it is possible for the topper effect producing device 428 to realize a variety of effects depending on how the CPU 491 selects the second effect information.

Also, in the heretofore described aspect in which the plurality of items of second effect information are stored in the ROM 494, it is also acceptable that the CPU 491, at the time of Step 3, changes second effect information to be selected from the ROM 494 every time the effect change condition is satisfied. The effect change condition includes an elapsing of a predetermined time period, a coming of a predetermined time, a reception or otherwise of a change signal from the illumination effect control circuit 461, a signal input of the lighting pattern switch 497 or the like. As the effect change condition, in a case of an aspect in which second effect information to be selected is changed in response to the signal input of the lighting pattern switch 497, it is possible, by an operation of the lighting pattern switch 497, to set to optional second effect information.

In this way, by changing the second effect information to be selected from the ROM 494 in response to the effect change condition, it is possible for the topper effect producing device 428 to realize various effect aspects corresponding to the effect change condition. Second effect information to be selected from the ROM 494 not necessarily being changed, even by simply randomly reselecting second effect information to be selected, every time the effect change condition is satisfied, it is possible to realize various effect aspects.

Although the above description has been given of the topper effect producing device 428 as an example of the effect device, the whole of the gaming machine 401 including the topper effect producing device 428 can also become the effect device. In this case, the gaming machine 401, having a system similar to or equivalent to the system in the block diagram of the topper effect producing device 428 shown in FIG. 45, receives the first effect information from the exterior of the gaming machine 401 (for example, a separate gaming machine, a game server or the like). Then, the gaming machine 401, based on the predetermined effect condition, transmits either the effect signal based on the first effect information or the effect signal based on the second effect information stored in effect information storage unit (for example, the ROM 434) of the gaming machine 401, and causes effect means (for example, the light emitting unit 420 or the speakers 423) to perform an effect corresponding to the signal. Accordingly, even in a case in which the gaming machine 401 itself is the effect device, in the same way as in a case in which the topper effect producing device 428 is the effect device, a diversification of effects by the gaming machine 401 is achieved, and the effect richer in variety is performed.

The present invention is not limited to the heretofore described embodiment. For example, the effect producing device may not be limited to the LED's 428b performing the illumination effect, but it is also acceptable that a device performing the sound effect, a device performing the image effect or the like is used as the effect producing device.

What is claimed is:

1. A gaming machine comprising:
a cabinet;
a display portion that is provided on the cabinet and displays information related to a game;
an operation unit that is provided on the cabinet and allows a player to input operations for playing the game; and
a plurality of light emitting units that are arranged to surround a game area defined on the cabinet to include the display portion and the operation unit.

2. The gaming machine according to claim 1 further comprising an inclined portion that is formed to incline more toward the display portion at a part where distant from the display portion,
wherein a subset of the light emitting units is disposed on the inclined portion.

3. The gaming machine according to claim 2, wherein the inclined portion is formed to incline more toward the display portion at a part where distant in a direction rearward from a front face of the display portion.

4. The gaming machine according to claim 2, wherein the incline portion is formed to protrude outward from a side face of the cabinet.

5. The gaming machine according to claim 1, further comprising a funnel-shaped reflecting face that is disposed to surround at least one of the light emitting units to reflect light emitted therefrom.

6. The gaming machine according to claim 5, wherein the reflecting face is formed to have a plurality of stepped faces having different depth.

7. The gaming machine according to claim 1 further comprising an illumination controller that controls the light emitting units to blink,
wherein a subset of the light emitting units are linearly arranged.

8. The gaming machine according to claim 7, wherein the light emitting units are grouped into a first subset being linearly arranged at a side of the display portion and a second subset being linearly arranged at a side of the operation unit and at below the operation unit, and
wherein an interval between each of the light emitting units of the first subset is configured to be narrower than an interval between each of the light emitting units of the second subset.

9. The gaming machine according to claim 1, wherein the operation unit is disposed below the display portion,
wherein the game area is defined as a rectangular shape, and
wherein the light emitting units are arranged to surround all of the four sides of the game area.

10. The gaming machine according to claim 1 further comprising a plurality of display devices that are provided within the display portion.

11. The gaming machine according to claim 10 further comprising a controller that operates to:
control the display devices to variably display a plurality of symbols for a predetermined time period when a start command is input through the operation unit to start the game; and
pay out an award to the player in accordance with a combination of the symbols displayed stopped.

12. A gaming machine comprising:
a cabinet;
a display portion that is provided on the cabinet and displays information related to a game;
an operation unit that is provided on the cabinet and allows a player to input operations for playing the game;
a plurality of light emitting units that are arranged to surround a game area defined on the cabinet to include the display portion and the operation unit; and
an inclined portion that is formed to incline more toward the display portion at a part where distant in a direction rearward from a front face of the display portion, the inclined portion being formed to protrude outward from a side face of the cabinet,
wherein a subset of the light emitting units is disposed on the inclined portion.

13. The gaming machine according to claim 12, further comprising a funnel-shaped reflecting face that is disposed to surround at least one of the light emitting units to reflect light emitted therefrom.

14. The gaming machine according to claim 13, wherein the reflecting face is formed to have a plurality of stepped faces having different depth.

15. The gaming machine according to claim 12 further comprising an illumination controller that controls the light emitting units to blink,
wherein a subset of the light emitting units are linearly arranged.

16. The gaming machine according to claim 15, wherein the light emitting units are grouped into a first subset being linearly arranged at a side of the display portion and a second subset being linearly arranged at a side of the operation unit and at below the operation unit, and
wherein an interval between each of the light emitting units of the first subset is configured to be narrower than an interval between each of the light emitting units of the second subset.

17. The gaming machine according to claim 12, wherein the operation unit is disposed below the display portion,
wherein the game area is defined as a rectangular shape, and
wherein the light emitting units are arranged to surround all of the four sides of the game area.

18. The gaming machine according to claim 12 further comprising a plurality of display devices that are provided within the display portion.

19. The gaming machine according to claim 18 further comprising a controller that operates to:
control the display devices to variably display a plurality of symbols for a predetermined time period when a start command is input through the operation unit to start the game; and
pay out an award to the player in accordance with a combination of the symbols displayed stopped.

20. A gaming machine comprising:
a cabinet;
a display portion that is provided on the cabinet and displays information related to a game;
a plurality of display devices that are provided within the display portion;
an operation unit that is provided on the cabinet and allows a player to input operations for playing the game;
a plurality of light emitting units that are arranged to surround a game area defined on the cabinet to include the display portion and the operation unit; and
a controller that operates to:
control the display devices to variably display a plurality of symbols for a predetermined time period when a start command is input through the operation unit to start the game; and
pay out an award to the player in accordance with a combination of the symbols displayed stopped; and
an inclined portion that is formed to incline more toward the display portion at a part where distant in a direction rearward from a front face of the display portion, the inclined portion being formed to protrude outward from a side face of the cabinet,
wherein a subset of the light emitting units is disposed on the inclined portion.

21. The gaming machine according to claim 20, further comprising a funnel-shaped reflecting face that is disposed to surround at least one of the light emitting units to reflect light emitted therefrom.

22. The gaming machine according to claim 21, wherein the reflecting face is formed to have a plurality of stepped faces having different depth.

23. The gaming machine according to claim 20 further comprising an illumination controller that controls the light emitting units to blink,
wherein a subset of the light emitting units are linearly arranged.

24. The gaming machine according to claim 23, wherein the light emitting units are grouped into a first subset being linearly arranged at a side of the display portion and a second subset being linearly arranged at a side of the operation unit and at below the operation unit, and
wherein an interval between each of the light emitting units of the first subset is configured to be narrower than an interval between each of the light emitting units of the second subset.

25. The gaming machine according to claim 20, wherein the operation unit is disposed below the display portion,
wherein the game area is defined as a rectangular shape, and
wherein the light emitting units are arranged to surround all of the four sides of the game area.
